(19) United States
(12) Patent Application Publication
(10) Pub. No.: US 2024/0023750 A1
(43) Pub. Date: Jan. 25, 2024

(54) TRANSPORTABLE FOOD WARMING MODULE METHOD AND DEVICES

(71) Applicant: Joe Ganahl, Honolulu, HI (US)

(72) Inventor: Joe Ganahl, Honolulu, HI (US)

(21) Appl. No.: 18/375,919

(22) Filed: Oct. 2, 2023

Related U.S. Application Data
(63) Continuation-in-part of application No. 17/838,138, filed on Jun. 10, 2022.
Application No. 17/838,138 is a continuation of application No. 17/536,049, filed on Nov. 28, 2021.
Application No. 17/536,049 is a continuation-in-part of application No. 16/459,795, filed on Jul. 2, 2019, now abandoned.
(60) Provisional application No. 62/694,981, filed on Jul. 7, 2018.

(51) Int. Cl. A47J 36/24; A47J 47/14; A47J 36/38; A23L 3/28; A47J 36/10; A47J 36/02

(52) U.S. Cl. CPC A47J 36/2483; A47J 47/14; A47J 36/38; A23L 3/28; A47J 36/10; A47J 36/025

(57) ABSTRACT

The embodiments disclose a food transport container for heating food in transport containers including at least one heat module insert device coupled to interior sides of transport containers configured for heating food at predetermined temperatures while the food is transported, at least one removable battery coupled to the at least one heat module insert device for powering heating plates, a charger base having a high power charger, high current connection configured to allow additional power and current capacity to effectively charge multiple removable batteries simultaneously, a heating plate coupled to the at least one removable battery configured to heat food, an electronic control board coupled to the heating plate to adjustably set heating plate temperatures, and a heat transfer protective piece coupled to the heating plate configured to shield the heating plate.

### CROSS-REFERENCE TO RELATED APPLICATIONS

This patent application is a Continuation-In Part and claims priority to United States patent application entitled: “TRANSPORTABLE FOOD WARMING MODULE METHOD AND DEVICES”, U.S. Ser. No. 17/838,138 filed on Jun. 10, 2022, by Joseph Ganahl, which is a Continuation-In Part of United States patent application entitled: “FOOD WARMING SYSTEM”, U.S. Ser. No. 17/536,049 filed on Nov. 28, 2021, by Joseph Ganahl, which is a Continuation-In Part of United States patent application entitled: “FOOD WARMING SYSTEM”, U.S. Ser. No. 16/459,795 filed on Jul. 2, 2019, by Joseph Ganahl, which claims priority to U.S. Provisional Patent Application Ser. No. 62/694,981 filed Jul. 7, 2018, entitled “FOOD WARMING SYSTEM”, by Joseph Ganahl, all being incorporated herein by reference.

### BACKGROUND

Food spoilage is a natural occurring process. When food is subjected to temperatures in the “danger zone” above 40 degree F. and below 140 degree F. the toxins multiply at an exponential rate. The toxins in turn leave bacteria on your food. Bacteria, yeasts and molds are among common causes of spoilage and food poisoning. Chilling food helps delay the food poisoning and spoiling process because the toxins grow at a slower rate, thus leaving fewer bacteria, and keeping food safe to eat for a longer period of time. Many portable containers are available to keep food chilled for a period of time. One impact of chilling food is that it can impact sensory details such as texture, taste, and smell. Human beings evolved to prefer hot food. Warmth enhances flavor on the sensory papillae of our tongues and heating food boosts its energy value.

### BRIEF DESCRIPTION OF THE DRAWINGS

FIG. 1 shows for illustrative purposes only an example of an overview of a food warming system container of one embodiment.

FIG. 2 shows for illustrative purposes only an example of a waterproof power button of one embodiment.

FIG. 3 shows for illustrative purposes only an example of a heat tray insert of one embodiment.

FIG. 4 shows for illustrative purposes only an example of a control printed circuit board assembly (PCBA) of one embodiment.

FIG. 5 shows for illustrative purposes only an example of a rechargeable battery pack of one embodiment.

FIG. 6 shows for illustrative purposes only an example of waterproof LED indicators of one embodiment.

FIG. 7 shows for illustrative purposes only an example of an exposed charge port of one embodiment.

FIG. 8 shows for illustrative purposes only an example of a food status audible and visual alert broadcast of one embodiment.

FIG. 9 shows for illustrative purposes only an example of a temperature control of one embodiment.

FIG. 10 shows for illustrative purposes only an example of a cover food ready alert LED of one embodiment.

FIG. 11 shows for illustrative purposes only an example of heat dispersing elements of one embodiment.

FIG. 12A shows for illustrative purposes only an example of food warming system food container cover and insert wall structures of one embodiment.

FIG. 12B shows for illustrative purposes only an example of a food warming system food container heat tray insert bottom structure of one embodiment.

FIG. 12C shows for illustrative purposes only an example of a PCBA insert wall structure of one embodiment.

FIG. 13 shows for illustrative purposes only an example of an overview of a food transport system heat module insert of one embodiment.

FIG. 14 shows for illustrative purposes only an example of heat module insert components of one embodiment.

FIG. 15 shows for illustrative purposes only an example of a soft-sided food transport container of one embodiment.

FIG. 16 shows for illustrative purposes only an example of a hard-sided food transport cart of one embodiment.

FIG. 17 shows for illustrative purposes only an example of a battery box of one embodiment.

FIG. 18 shows for illustrative purposes only an example of a battery of one embodiment.

FIG. 19 shows for illustrative purposes only an example of a temperature control of one embodiment.

FIG. 20 shows for illustrative purposes only an example of a food warming system digital application of one embodiment.

FIG. 21 shows for illustrative purposes only an example of a food and beverage transport container with handles down of one embodiment.

FIG. 22 shows for illustrative purposes only an example of a food and beverage transport container with handles up of one embodiment.

FIG. 23 shows for illustrative purposes only an example of a food and beverage transport container with the cover up of one embodiment.

FIG. 24 shows for illustrative purposes only an example of a stackable food tray insert of one embodiment.

FIG. 25 shows for illustrative purposes only an example of food and beverage transport container components of one embodiment.

FIG. 26 shows for illustrative purposes only an example of a top view of removable cup holder insert of one embodiment.

FIG. 27 shows for illustrative purposes only an example of an exploded view of food and beverage transport container stackable food tray components of one embodiment.

FIG. 28 shows for illustrative purposes only an example of a top view of cold drink transporter of one embodiment.

FIG. 29 shows for illustrative purposes only an example of a top view of a countertop cup heating tray of one embodiment.

FIG. 30 shows for illustrative purposes only an example of a top view of a countertop cup heating tray components of one embodiment.

FIG. 31 shows for illustrative purposes only an overview example of an Automatic multi-unit charging nest 3100 with Transport Boxes installed for charging of one embodiment.

FIG. 32 shows for illustrative purposes only an example of a detailed view of charging nest of one embodiment.

FIG. 33 shows for illustrative purposes only an example of a detailed view of Charging Nest with Charging Spring pin of one embodiment.

FIG. 34 shows for illustrative purposes only an example of a chafer transportable food warming module of one embodiment.

FIG. 35 shows for illustrative purposes only an example of a chafer transportable food warming module components of one embodiment.

FIG. 36 shows for illustrative purposes only an example of an overview of a small pizza delivery bag of one embodiment.

FIG. 37 shows for illustrative purposes only an example only an example of an exploded view of a small pizza delivery bag of one embodiment.

FIG. 38A shows for illustrative purposes only an example of battery attachment to heat element with a socket of one embodiment.

FIG. 38B shows for illustrative purposes only an example battery attachment to heat element with a plug of one embodiment.

FIG. 39 shows for illustrative purposes only an example of an overview of an optional shelf system of one embodiment.

FIG. 40 shows for illustrative purposes only an example of an overview of a food transport heat system of one embodiment.

FIG. 41 shows for illustrative purposes only an example of an overview of heater assembly of one embodiment.

FIG. 42A shows for illustrative purposes only an example of an overview of a soft sided food transport container of one embodiment.

FIG. 42B shows for illustrative purposes only an example of an overview of an optional shelf system of one embodiment.

FIG. 43 shows for illustrative purposes only an example of an overview of monitoring food temperature in real time of one embodiment.

FIG. 44A shows for illustrative purposes only an example of an overview of a heater assembly of one embodiment.

FIG. 44B shows for illustrative purposes only an example of an overview of a battery assembly of one embodiment.

FIG. 45A shows for illustrative purposes only an example of an overview of an air flow director of one embodiment.

FIG. 45B shows for illustrative purposes only an example of an overview of a mounting plate with snaps of one embodiment.

FIG. 46A shows for illustrative purposes only an example of an overview of a high power multi battery charger of one embodiment.

FIG. 46B shows for illustrative purposes only an example of an overview of a charger base of one embodiment.

FIG. 46C shows for illustrative purposes only an example of an overview of a battery high current charge connectors of one embodiment.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### General Overview:

It should be noted that the descriptions that follow, for example, in terms of transportable food warming module method and devices is described for illustrative purposes and the underlying system can apply to any number and multiple types of food preparation processes. In one embodiment of the present invention, the transportable food warming module method and devices can be configured using different types of foods. The transportable food warming module method and devices can be configured to include soft-sided food transport container and can be configured to include hard-sided rolling food transport container using the present invention.

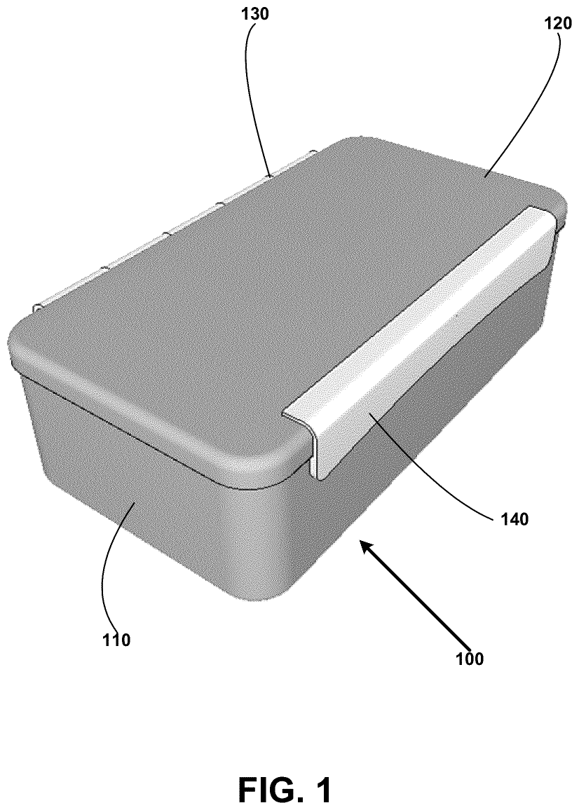

FIG. 1 shows for illustrative purposes only an example of an overview of a food warming system container of one embodiment. FIG. 1 shows a food warming system food container 100 in a closed position including a main body 110 and cover 120 to prevent outside contamination while in operation of warming food. The cover 120 includes a cover hinge 130 coupled to the main body 110 for opening and closing the food container 100 and a cover clasp 140 to securely seal the food container when closed in locked position of one embodiment.

The food warming system is a portable container for storing chilled food with an integral heating system to warm the food when ready to eat. The food container 100 is the main container designed for food storage. The food container 100 has a main body 110 which is a concave cavity where food is stored. A cover 120 seals the main body 110 closed to prevent food escaping. The cover 120 may be hinged and secured with a single clasp or completely removable and sealed with 4 clasps, one on each side or other closure and seal systems. A heat tray insert is integrated inside the main body and contains all the elements for heating food. A rechargeable battery pack provides power to operate the system of one embodiment.

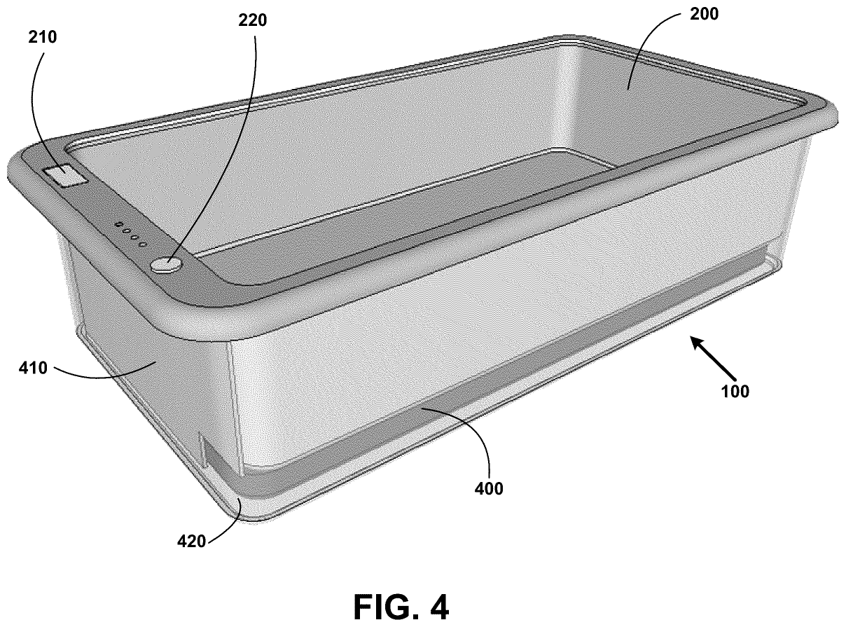

The rechargeable battery pack is directly connected to a control printed circuit board assembly (PCBA) 410 of FIG. 4 which controls power flow, temperature, charging and all battery safety protocols. A power button is also connected to the PCBA and is used to activate the system. When the system is activated, electrical power flows though the PCBA and is converted to heat which is then distributed along the heat tray insert foil tape or other conductors that surrounds food. A series of LED indicators are also connected to the PCBA and show a power level of the rechargeable battery pack. Charging the rechargeable battery pack is accomplished via a battery charge port.

When not in use the battery charge port is sealed with a waterproof cover to prevent moisture leakage into the battery charge port. The waterproof cover is removed for charging and a charger plug is inserted into the battery charge port of one embodiment. The food warming system food container forms a self-contained, lightweight, compact, battery powered, food safe, waterproof compartment with surrounding heat elements, adaptable to virtually any food container type. The food warming system container may be fabricated using stainless steel interior insulated walls with exterior plastic jacketing. The exterior plastic jacketing may be fabricated using plastic injection, co molded silicone injection, Surface Mount (SMT) assembly providing low cost and scalable manufacturing systems of one embodiment.

### DETAILED DESCRIPTION

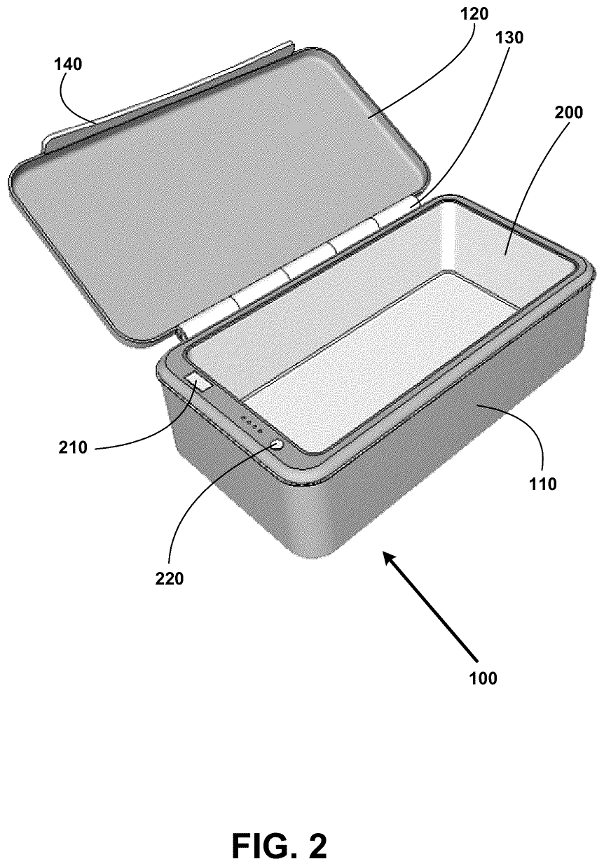

FIG. 2 shows for illustrative purposes only an example of a waterproof power button of one embodiment. FIG. 2 shows the food container 100, main body 110, cover 120 in an opened position, cover hinge 130, and the cover clasp 140 unlocked. A heat tray insert 200 is shown integrated into the food container 100. A waterproof charge port cover 210 is shown with a waterproof cover installed. A waterproof power button 220 is used to activate and deactivate the heating and control systems. The waterproof power button 220 waterproofing prevents moisture from entering the power circuits and creating a short of one embodiment.

The food warming system devices are configured to be easily portable so that food can be warmed anywhere. The food warming system devices are self-contained, food safe and waterproof so that liquidus foods will not damage the system. Power is supplied by a customized rechargeable battery pack. Heating power, charging and battery safety circuits are all contained in the PCBA. When the system is activated the PCBA will convert electrical energy to heat energy and disperse it through conductors including for example foil tape conductors or other conductors of one embodiment.

These conductors are placed along the walls and bottom of the heat tray insert 200 and, in some embodiments, along the cover inside surface. The heat elements completely surround the food and transfer heat into the food for warming. The food warming system heating systems are attached to a stainless steel shell and heat is transmitted through shell directly to the food which is placed within the stainless steel shell by generating heat in the food container using the electrical impedance of a plurality of heat dispersing elements one embodiment.

The food warming system devices may be configured in shapes and sizes for various food types and natures for example round, oblong, or other shapes and sizes. For example, one shape and size for a typical sandwich with square shaped bread slices, in another example where the interior space is compartmentalized to separate for example soups from dry foods. In other embodiments the food warming system devices may be configured for specific user activities for example travel in a commercial airlines where the rechargeable battery pack is of a type and design that meet TSA regulations, the food container seals when closed prevent any leakage, and the cover clasp 140 is configured to be child-proof and cannot be accidentally opened by contact with other objects.

In yet other embodiments the food warming system devices may be configured for keeping foods placed inside cold for example ice creams, fresh fruit and salads to prevent wilting and maintaining the food below 40 degrees F. to prevent bacterial growth until the user is ready to warm the food if desired.

### A Heat Tray Insert:

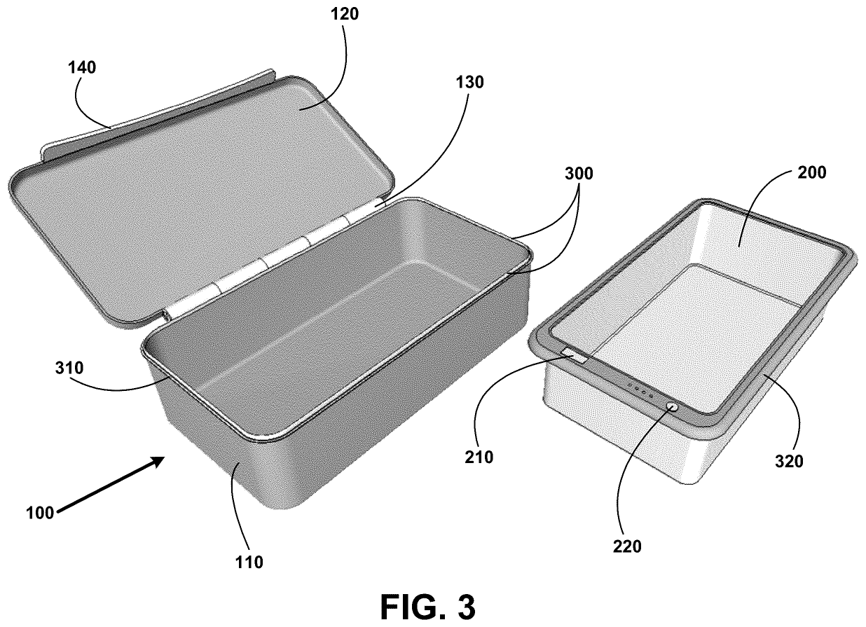

FIG. 3 shows for illustrative purposes only an example of a heat tray insert of one embodiment. FIG. 3 shows the food container 100, main body 110, cover 120 in an opened position, cover hinge 130, and unlocked cover clasp 140 with the integral heat tray insert 200 removed and set alongside. The waterproof charge port cover 210 and waterproof power button 220 can be seen on one side of a heat tray insert mounting ledge 320. The heat tray insert guide rail 300 is configured to provide a cover sealing ledge 310 of one embodiment.

### A Control Printed Circuit Board Assembly (PCBA):

FIG. 4 shows for illustrative purposes only an example of a control printed circuit board assembly (PCBA) of one embodiment. FIG. 4 shows the food container 100 heat tray insert 200 with a heat tray insert main body translucent view 420 of exterior wall surfaces for illustrative purposes only. Also seen are the waterproof charge port cover 210 and waterproof power button 220. Showing underneath the heat tray insert 200 inner surface is a rechargeable battery pack 400. Showing inside the translucent wall is at least one control printed circuit board assembly (PCBA) 410 in this example at one end of the heat tray insert 200.

The control printed circuit board assembly (PCBA) 410 is electrically coupled to the rechargeable battery pack 400. The control printed circuit board assembly (PCBA) 410 is coupled to a battery charge level device and an infrared thermometer sensor for monitoring food temperature in real time. The control printed circuit board assembly (PCBA) 410 includes at least one digital processor, at least one digital memory device, at least one database; at least one infrared thermometer coupled to the PCBA, at least one chemical vapor sensing device, at least one circuit coupled to the food container 100 cover 120, at least one circuit coupled to at least one digital temperature display, at least one circuit coupled to an alert light coupled to the cover 120, and at least one circuit coupled to a temperature control selection device mounted on the heat tray insert 200 insert mounting ledge 320 of FIG. 3.

At least one chemical vapor sensing device is used to analyze odors from the food placed in the heat tray insert 200. The at least one chemical vapor sensing device detects the chemical signatures of spoiled food odors, food borne pathogens for example salmonella and other food conditions that may cause a food consumer to become ill or even die. The chemical vapor sensing device coupled to the control printed circuit board assembly (PCBA) 410 performs the chemical analysis to determine the chemical formulae of the vapor elements.

At least one digital processor is used to search at least one digital memory device database for the identity of the chemical formulae from the chemical compound data prerecorded and stored in that database. Should the identified chemical formulae be a categorized as a health hazard, the PCBA will transmit an alert to the user to dispose of the food and not eat the food and identify the potential health hazard detected. Embodiments may include using at least one digital memory device database for recording data on various food stuffs to include recipe ingredients, characteristics, visual examples, cooking instructions with minimum food safety temperatures, precautions, spoilage indications and signs, and other information for keeping foods safe for consumption.

In another embodiment the identified chemical formulae are transmitted to a food warming system digital application on a user's digital device. The food warming system digital application is configured to perform an internet search for information to determine if the identified chemical formulae are categorized as a health hazard. The food warming system digital application will automatically display a visual warning and broadcast an audible alert to the user regarding the potential health hazard that has been determined.

In another embodiment the user may enter the type of food to be placed in the food warming system into the food warming system digital application installed on the user's digital device. The food warming system digital application will perform a search and display recipe ingredients, characteristics, visual examples, cooking instructions with minimum food safety temperatures, precautions, spoilage indications and signs, and other information for keeping foods safe for consumption.

The control printed circuit board assembly (PCBA) 410 includes at least one cellular connectivity device and transceiver for transmitting food status signal alerts, battery charge alerts and receiving user turn-off instructions. The control printed circuit board assembly (PCBA) 410 includes connectivity devices to Bluetooth and Wi-Fi to provide communication and control alternatives to the user including voice activated commands.

A rheostat device for regulating power levels conducting battery energy to a plurality of heat dispensing elements is also controlled by the control printed circuit board assembly (PCBA) 410 of one embodiment. The rechargeable battery pack 400 provides power to operate the food warming system components. The control printed circuit board assembly (PCBA) 410 controls power flow, temperature, charging and all battery safety protocols. The waterproof power button 220 is also coupled to the control printed circuit board assembly (PCBA) 410 and rechargeable battery pack 400 and is used to activate the system. When the system is activated, electrical power flows though PCBA and is converted to heat which is then distributed along the heat tray insert 200 conductors that surround food placed inside the heat tray insert 200. The LED indicators are also connected to PCBA and show power levels of the rechargeable battery pack 400 of one embodiment.

### A Rechargeable Battery:

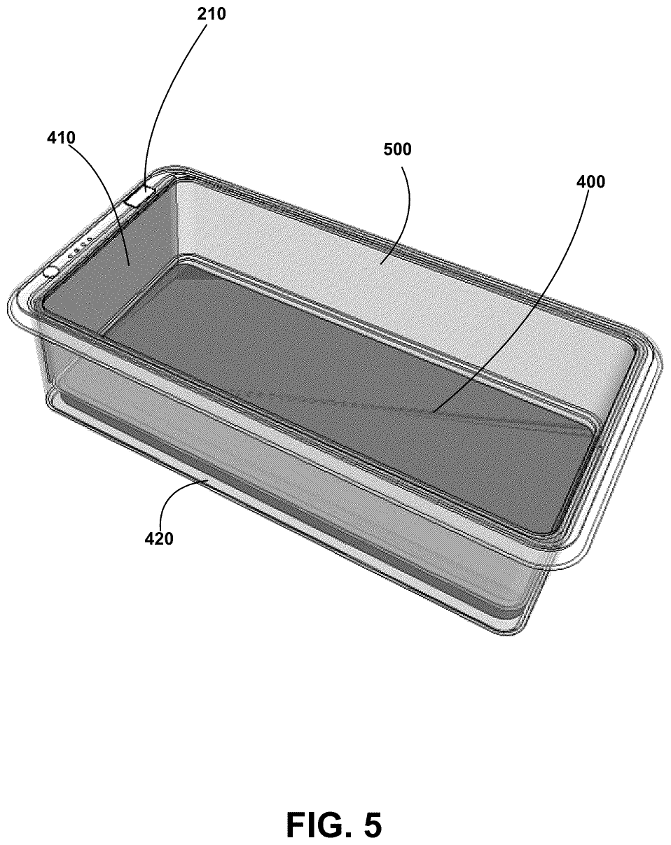

FIG. 5 shows for illustrative purposes only an example of a rechargeable battery pack of one embodiment. FIG. 5 shows a heat tray insert translucent view 500 and the main body translucent view 420 for illustrative purposes only. The waterproof charge port cover 210 is seen covering the charge port not showing. The rechargeable battery pack 400 may include for example a lithium ion rechargeable battery pack, lithium polymer (LiPo) rechargeable battery, rechargeable aluminum-based batteries, rechargeable nickel-iron battery and other rechargeable battery types. The control printed circuit board assembly (PCBA) 410 may include a plurality of printed circuits configured for differing functions including electronic components and circuits for controlling the various food warming system operations as described above and in the following descriptions. The control printed circuit board assembly (PCBA) 410 includes multiple safety systems for battery charging and operation of one embodiment.

### Waterproof LED Indicators:

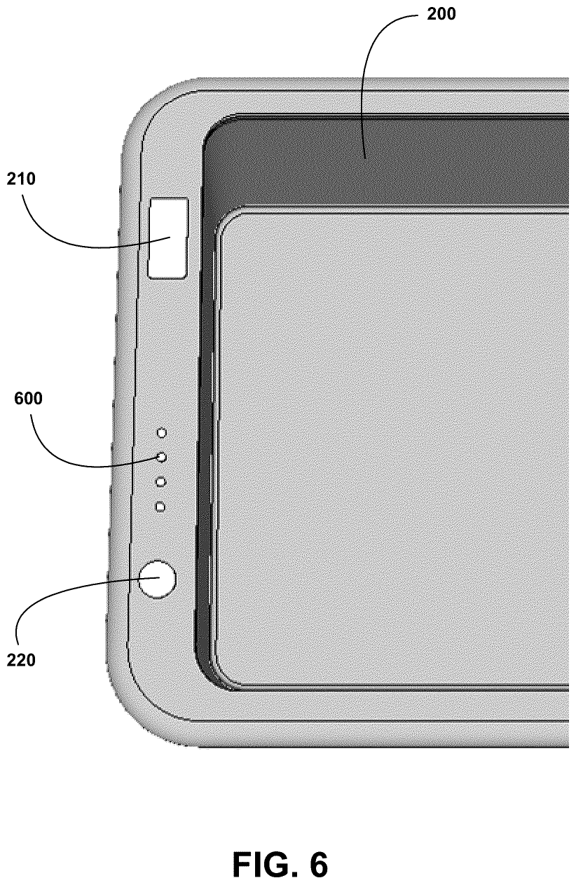

FIG. 6 shows for illustrative purposes only an example of waterproof LED indicators of one embodiment. FIG. 6 shows the heat tray insert 200 with the waterproof charge port cover 210 and waterproof power button 220. Also seen are a series of waterproof LED indicators 600. The waterproof LED indicators 600 include LED lights in for example a series of different colors to indicate the current battery charge of the rechargeable battery pack 400 of FIG. 4. The control printed circuit board assembly (PCBA) 410 of FIG. 4 is configured to transmit battery charge alert signals to a user's digital device to make them aware of a possible action to connect the rechargeable battery pack 400 of FIG. 4 to an external power source for recharging using the charging port and a charger plug of one embodiment.

### An Exposed Charge Port:

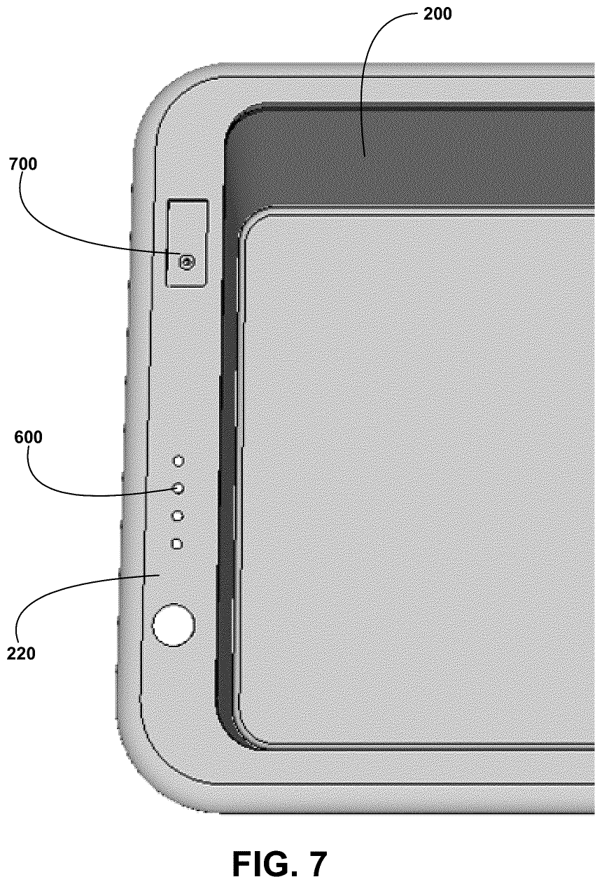

FIG. 7 shows for illustrative purposes only an example of an exposed charge port of one embodiment. FIG. 7 shows the waterproof power button 220, waterproof LED indicators 600 and heat tray insert 200 with an exposed charge port 700 wherein the waterproof charge port cover 210 of FIG. 2 has been removed. The waterproof charge port cover 210 of FIG. 2 is removed when the rechargeable battery pack 400 of FIG. 4 is being recharged using a charger plug connected to an external power source and is plugged into the exposed charge port 700 of one embodiment.

### A Food Status Audible and Visual Alert Broadcast:

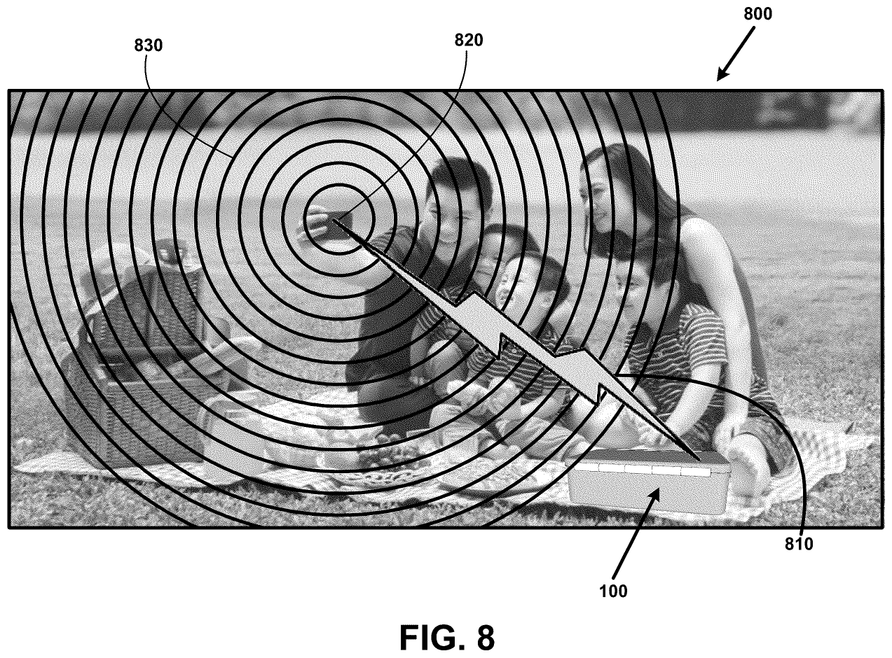

FIG. 8 shows for illustrative purposes only an example of a food status audible and visual alert broadcast of one embodiment. FIG. 8 shows the food warming system food container 100 being used by a family having a picnic 800. During the period of time the food is being heated to a safe temperature the users may be engaged in a physical activity or for example as shown taking a selfie of the fun time they are enjoying having a picnic. These activities may distract the family member that placed the food into the food container 100 for warming.

To alert the person that the food is ready to be served a heat tray transceiver transmitting food status signal alert 810 to the user digital device provides notice that the food is ready. In addition the heat tray transceiver is configured to include transmitting a food status audible alert broadcast 830. The heat tray transceiver food status signal alert 810 and food status audible alert broadcast 830 using cellular connectivity provides signals for a user digital device including a user smart phone receiving and broadcasting food status alerts 820 to alert the user to attend to the food warming status.

The food warming system includes a food warming system digital application for installing on a user's digital device including for example a smart phone, tablet, laptop computer and other digital devices. The food warming system digital application installed on a user's digital device is configured for displaying the food status alerts on a digital screen and broadcasting audible food status alerts. The user can tap the food warming system digital application icon and receive intermediate food status alerts to check the current temperature and a calculated approximate time remaining for the food to reach a safe temperature.

In one embodiment the food warming system digital application may display the temperature selection controls of the food warming food container. This allows the user to set the desired temperature using the user's digital device. The user may want to turn off or adjust the temperature which they can perform using the food warming system digital application of one embodiment.

### A Temperature Control:

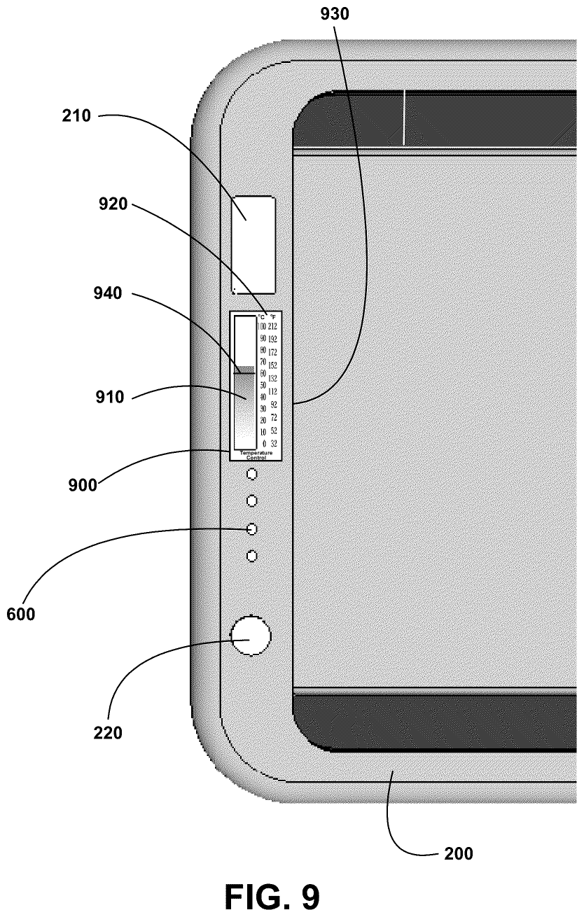

FIG. 9 shows for illustrative purposes only an example of a temperature control of one embodiment. FIG. 9 shows the heat tray insert 200, waterproof power button 220; waterproof LED indicators 600 and the waterproof charge port cover 210. Also shown is a temperature control 900. The temperature control 900 is coupled to the control printed circuit board assembly (PCBA) 410 of FIG. 4. The temperature control 900 is configured for the user to set a temperature for warming the food placed in the food warming system.

The temperature control 900 includes a temperature setting touch screen slide 910 adjusting feature. The temperature setting touch screen slide 910 is adjustable using degrees Celsius and degrees Fahrenheit temperature scales 920. The temperature control 900 includes monitoring food temperature in real time using at least one infrared thermometer 930 that is coupled to the control printed circuit board assembly (PCBA) 410 of FIG. 4 and temperature control 900. The temperature setting touch screen slide 910 includes a safe temperature limit 940 indicating line to remind the user not to set a temperature above that limit of one embodiment.

In another embodiment the temperature control 900 includes digital touch buttons labeled for specific food types for example soups, sandwiches, stews, vegetables, and others. The digital touch buttons labeled for specific food types when pressed will set the targeted temperature setting to preset temperatures prerecorded in one of the at least one databases.

### A Cover Food Ready Alert LED:

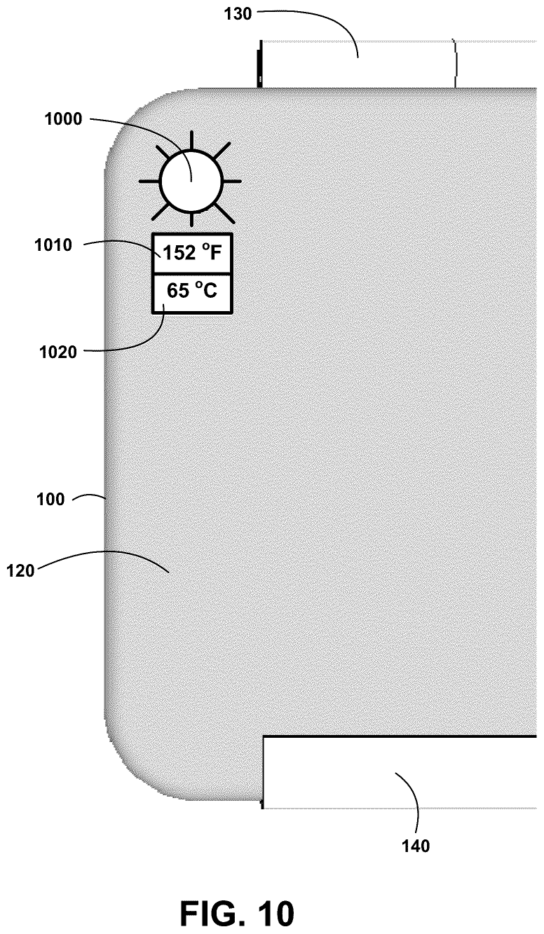

FIG. 10 shows for illustrative purposes only an example of a cover food ready alert LED of one embodiment. FIG. 10 shows the food container 100 cover 120, cover hinge 130 and cover clasp 140. In one embodiment the cover 120 includes a food ready alert LED 1000, a food temperature digital display in degrees Fahrenheit 1010 and a food temperature digital display in degrees Celsius 1020.

The food status audible alert broadcast 830 of FIG. 8 can be heard by a user with a visual impairment. The food ready alert LED 1000, food temperature digital display in degrees Fahrenheit 1010 and food temperature digital display in degrees Celsius 1020 can be seen by users with hearing impairments. In another embodiment the temperature readings in degrees Fahrenheit and degrees Celsius may be electronic vocalizations using a text reader. This feature can be configured to broadcast the electronic vocalizations in languages selected by the user using the food warming system digital application of one embodiment.

### Heat Dispersing Elements:

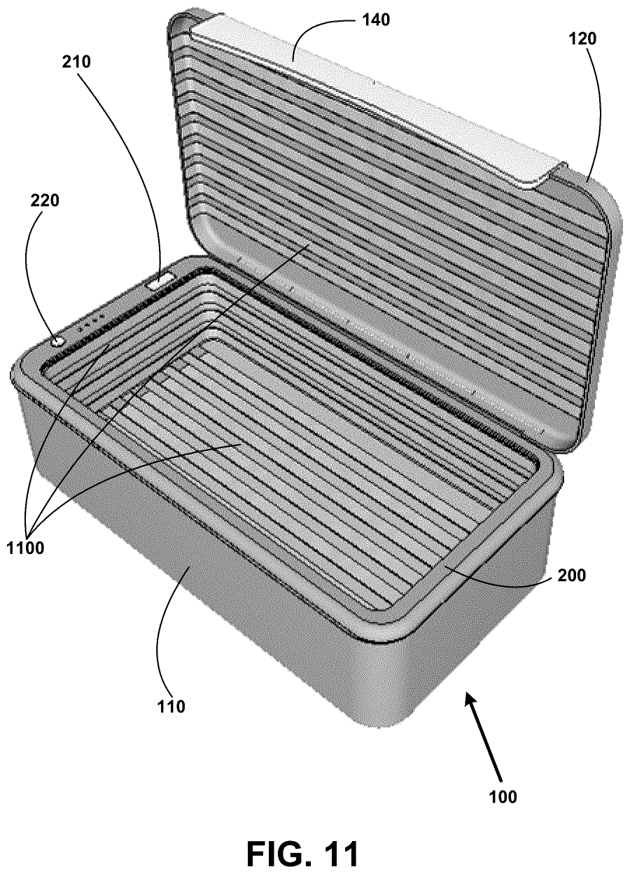

FIG. 11 shows for illustrative purposes only an example of heat dispersing elements of one embodiment. FIG. 11 shows the food container 100 including the main body 110, cover 120, cover clasp 140, heat tray insert 200, waterproof charge port cover 210 and waterproof power button 220. Also showing is a plurality of heat dispersing elements 1100 exposed for illustrative purposes only. The plurality of heat dispersing elements 1100 are heat tray insert conductors positioned to surround food placed in the food container with the heat tray insert. The interior surfaces of the food container and heat tray insert are stainless steel. The conductors are positioned directly beneath the stainless steel interior enclosure structures and conduct heat directly through the stainless steel material to warm the food placed against and near the interior surfaces.

When the system is activated, electrical power from the rechargeable battery pack 400 of FIG. 4 flows though at least one control printed circuit board assembly (PCBA) 410 of FIG. 4 and is converted to heat through the electrical impedance of the conductors. The control printed circuit board assembly (PCBA) 410 of FIG. 4 uses the real-time temperature monitoring of at least one infrared thermometer 930 of FIG. 9 to regulate the amperage and voltage flowing to each of the conductors. Regulating the amperage and voltage flowing to each of the conductors controls the heat produced by the electrical impedance for adjusting the heat emanating from the plurality of heat dispersing elements 1100 in the interior surface regions to provide even heating of the food.

In another embodiment the heat tray insert 200 and food container 100 cover 120 include ultraviolet (UV) lights to treat the food placed in the heat tray insert 200 to kill bacteria, viruses and other food borne pathogens and sterilize the food before, during and after the warming processes.

### Food Warming System Food Container Cover and Insert Wall Structures:

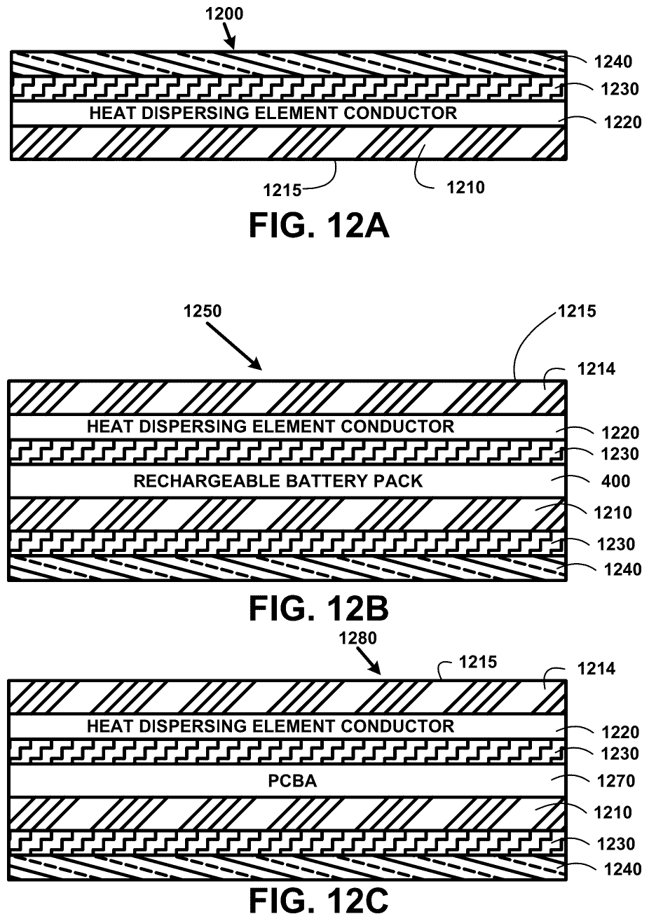

FIG. 12A shows for illustrative purposes only an example of food warming system food container cover and insert wall structures of one embodiment. FIG. 12A shows food warming system food container covers and insert wall structures 1200. The wall structures include a stainless steel shell 1210 that provides an interior surface facing food 1215 that is placed in the food warming system. Also showing is a heat dispersing element conductor 1220 that is attached to the stainless steel shell 1210 and coupled to at least one control printed circuit board assembly (PCBA) 410 of FIG. 4. The wall structures include an insulation 1230 layer that is surrounded by an exterior plastic jacket 1240 of one embodiment.

### A Food Warming System Food Container Heat Tray Insert Bottom Structure:

FIG. 12B shows for illustrative purposes only an example of a food warming system food container heat tray insert bottom structure of one embodiment. FIG. 12B shows a food warming system food container heat tray insert bottom structure 1250. The insert bottom structure includes an interior surface facing food 1215 of an inner stainless steel shell 1214 with a heat dispersing element conductor 1220 attached. An insulation 1230 layer is positioned between the heat dispersing element conductor 1220 and rechargeable battery pack 400. An outer stainless steel shell 1210 provides exterior support and includes an insulation 1230 layer with an exterior plastic jacket 1240 of one embodiment.

### A PCBA Insert Wall Structure:

FIG. 12C shows for illustrative purposes only an example of a PCBA insert wall structure of one embodiment. FIG. 12C shows a PCBA insert wall structure 1280 showing in a horizontal orientation for illustrative purpose, but is normally in a vertical orientation at one end of the food container. The PCBA insert wall structure 1280 includes an interior surface facing food 1215 of the inner stainless steel shell 1214. A heat dispersing element conductor 1220 is shown attached to the inner stainless steel shell 1214 for transmitting heat through the inner stainless steel shell 1214 to warm the food placed in the food warming system food container. An insulation 1230 layer is placed between the PCBA 1270 and the heat dispersing element conductor 1220. The outer stainless steel shell 1210 is used for providing exterior support and for supporting the PCBA 1270 attachment. A second insulation 1230 layer is positioned between the outer stainless steel shell 1210 and the exterior plastic jacket 1240 of one embodiment.

### Heat Module Insert:

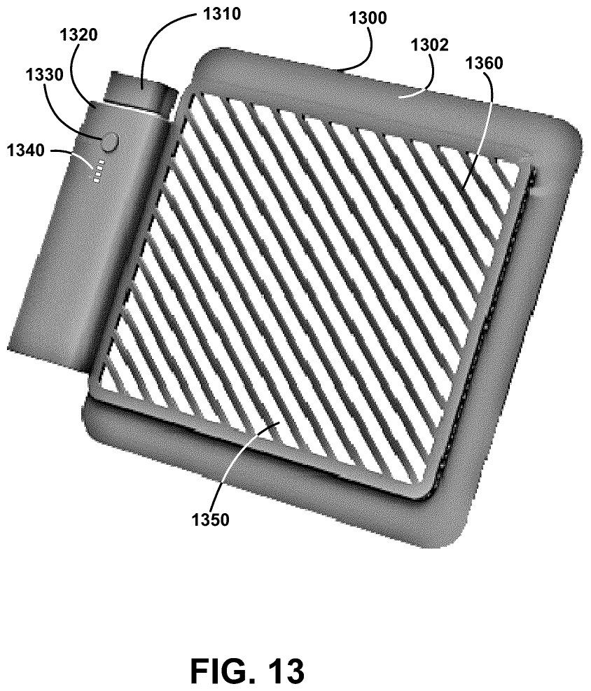

FIG. 13 shows for illustrative purposes only an example of an overview of a food transport system heat module insert of one embodiment. FIG. 13 shows a heat module insert for a warming device for food transport. In one embodiment a warming device for food transport can be in a bag. In another embodiment a warming device for food transport can be in an easily transportable cabinet. A warming device for food transport is used for grocery delivery services, catering trays, pizza delivery bags, and other food transport containers.

FIG. 13 shows a heat module insert 1300 with a battery 1310, integrated battery box and back support 1320, waterproof power button 1330, waterproof LED display 1340, aluminum protective piece 1350, and plastic screen 1360.

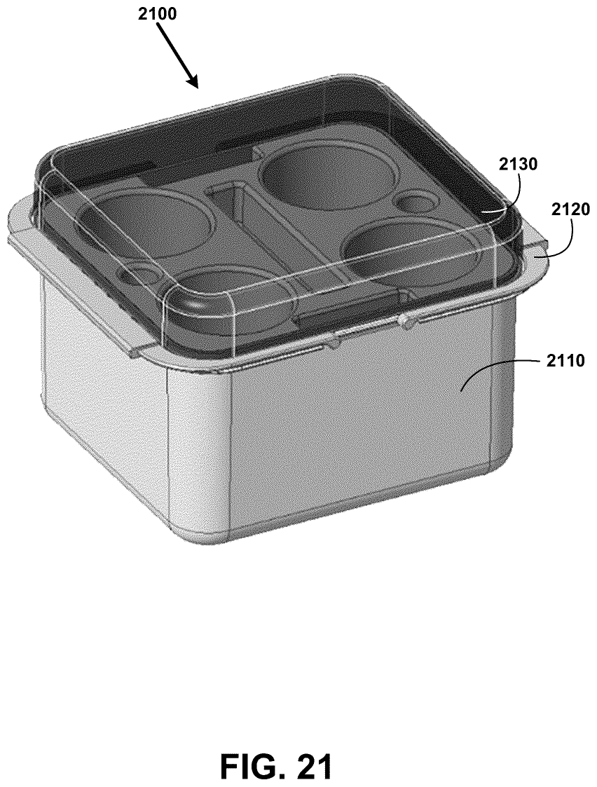

The food system heat module insert 1300 is a portable device for maintaining hot food temperature inside a food transport container 2100 of FIG. 21. The food system heat module insert 1300 is a portable and interchangeable heating device. The food system heat module insert 1300 has an integrated battery box and back support 1320 which is the primary structural element the rest of module is attached to. A battery 1310 is installed directly into the battery box with an O-ring waterproof seal to protect against spillage. A heat plate is integrated inside the main body and contains the elements for heating the food transport container 2100 of FIG. 21. In one embodiment a rechargeable battery pack 400 of FIG. 4 provides power to operate the warming device system of one embodiment.

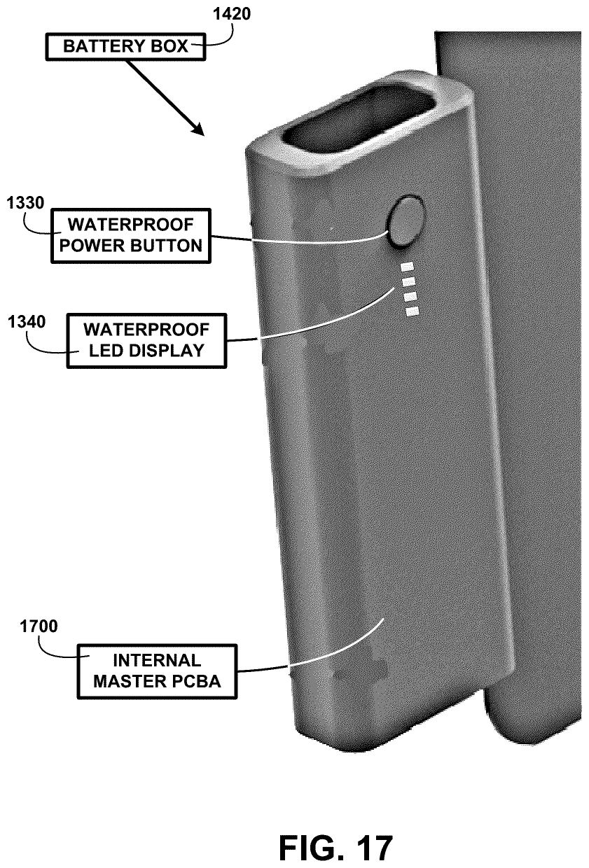

The rechargeable battery pack 400 of FIG. 4 is directly connected to a control printed circuit board assembly (PCBA) 1700 of FIG. 17, installed in the base of battery box, which controls power flow, temperature, charging and all battery safety protocols. The waterproof power button 1330 is also connected to the PCBA 1700 of FIG. 17 and is used to activate the system. When the system is activated, electrical power flows though the PCBA 1700 of FIG. 17 and is converted to heat which is then distributed along the heat plate or other conductors that distribute heat into the food transport container 2100 of FIG. 21. A series of LED indicators of the waterproof LED display 1340 are also connected to the PCBA 1700 of FIG. 17 and show a power level of the rechargeable battery pack 400. Charging the rechargeable battery pack 400 of FIG. 4 is accomplished via a separate battery charge unit. The battery 1310 is removed from device and installed in a charger unit for charging.

The food system heat module insert 1300 forms a self-contained, lightweight, compact, battery powered, food safe, waterproof device with heat elements, adaptable to virtually any food transport container type. The exterior plastic jacketing 1302 may be fabricated using plastic injection, co molded silicone injection, Surface Mount (SMT) assembly providing low cost and scalable manufacturing systems of one embodiment.

The heat module insert is a universal heat module insert device for heating food in predetermined transport containers. The universal heat module insert device is coupled to interior sides of predetermined transport containers configured for heating food at predetermined temperatures while the food is being transported. The predetermined transport containers include multiple diverse and varying transport containers that are universally configured with interior side surface capability for attaching at least one heat module insert device. The universal heat module insert device includes at least one battery for powering a heating plate. The heating plate is used to heat food. An electronic control board is coupled to the heating plate to adjustably set heating plate temperatures. A back support within the universal heat module insert device provides structural support. A heat transfer protective piece is coupled to the heating plate to shield the heating plate from other components.

### Heat Module Insert Components:

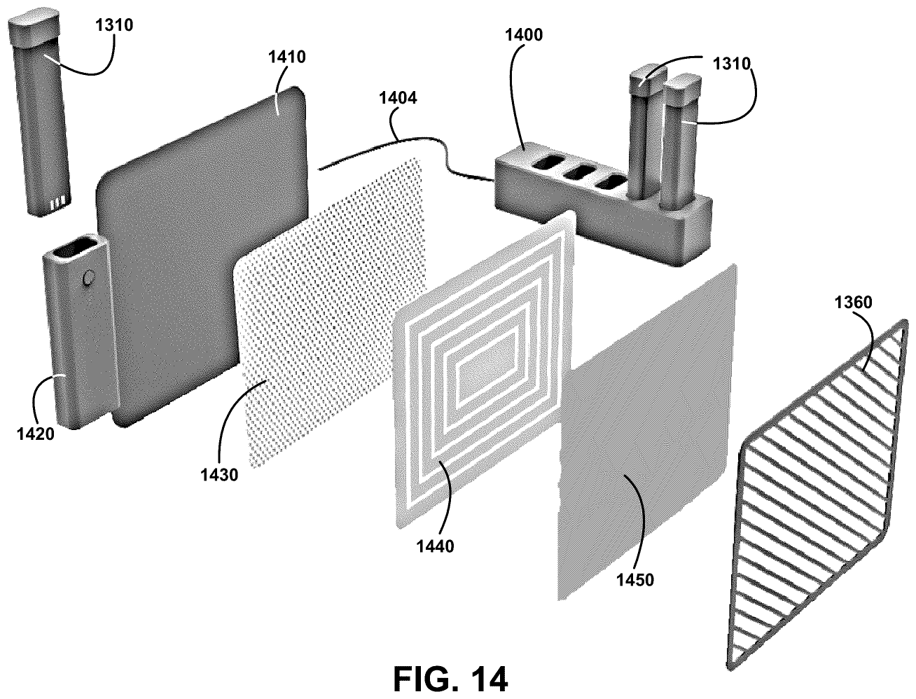

FIG. 14 shows for illustrative purposes only an example of heat module insert components of one embodiment. FIG. 14 shows power components including at least one battery 1310 and an accessory multi-unit battery charger 1400 with an AC adapter cord 1404 for recharging at least one battery 1310. An integrated plastic back plate 1410 is coupled to a battery box 1420 to hold at least one battery 1310. An insulation and reflective aluminum 1430 to provide insulation from a heat plate 1440 to the integrated plastic back plate 1410. An aluminum protective plate 1450 provides protection to the heat plate 1440 and transfers heat directly into the food container from the heat plate 1440. A plastic screen 1360 on the outer surface of the transportable food warming module protects fingers and contents from being burned by contact with aluminum plate 1450.

The heat module insert 1300 of FIG. 13 is configured to be easily portable so that food can be warmed in multiple diverse and varying transport containers. The heat module insert 1300 devices are self-contained, food safe and waterproof so that liquidus food spillage will not damage the system. Power is supplied by a customized rechargeable battery pack 400 of FIG. 4. Heating power, charging and battery safety circuits are all contained in the PCBA 1700 of FIG. 17. When the system is activated the PCBA 1700 of FIG. 17 will convert electrical energy to heat energy and disperse it through conductors including for example the heat plate 1440 or other conductors of one embodiment.

The heat module insert 1300 is placed along the sides of transport container 2100 of FIG. 21 and, in some embodiments; multiple units may be used in one transport container 2100 of FIG. 21. The heat elements transfer heat into the transport container 2100 of FIG. 21 to help keep food warm. The transportable food warming module systems are attached to the inner surface of food transport container 2100 of FIG. 21 with Velcro in one embodiment. Other embodiments could include brackets, clips, or other attachment systems.

The transportable food warming module 1300 of FIG. 13 may be configured in shapes and sizes for various transport container types and sizes. For example one shape and size for a portable food transport bag, in another example for a larger rolling food transport cart. In other embodiments the food warming system devices may be configured for specific food types for example a pizza delivery bag.

### Soft-Sided Food Transport Container:

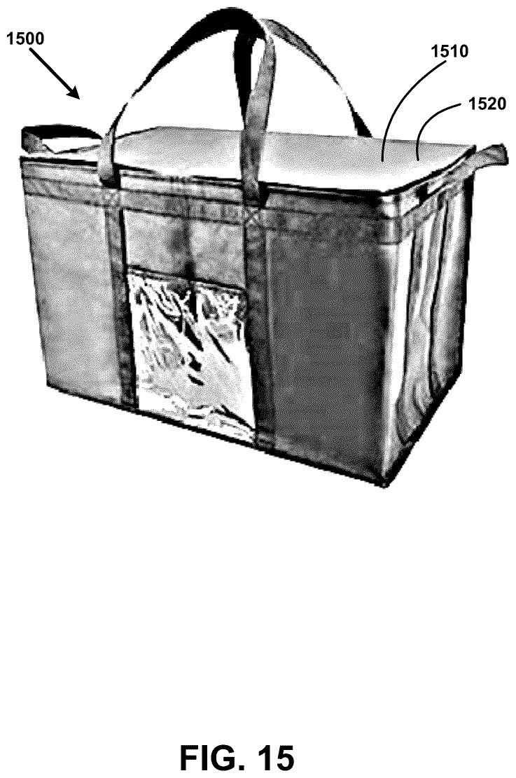

FIG. 15 shows for illustrative purposes only an example of a soft-sided food transport container of one embodiment. FIG. 15 shows a soft-sided food transport container 1500 with a protective food container cover 1510. The heat module insert 1300 of FIG. 13 is placed along the sides of the transport container 2100 of FIG. 21 and, in some embodiments; multiple units may be used in one transport container 2100 of FIG. 21. At least one heat module insert 1300 of FIG. 13 may be transported with the heater operating at a safe temperature for the food for delivery to a consumer. In one embodiment the soft-sided food transport container and cover include ultraviolet lights 1520 to treat the food to kill bacteria, viruses and other food borne pathogens and sterilize the food before, during and after the warming processes of one embodiment.

### Hard-Sided Food Transport Cart:

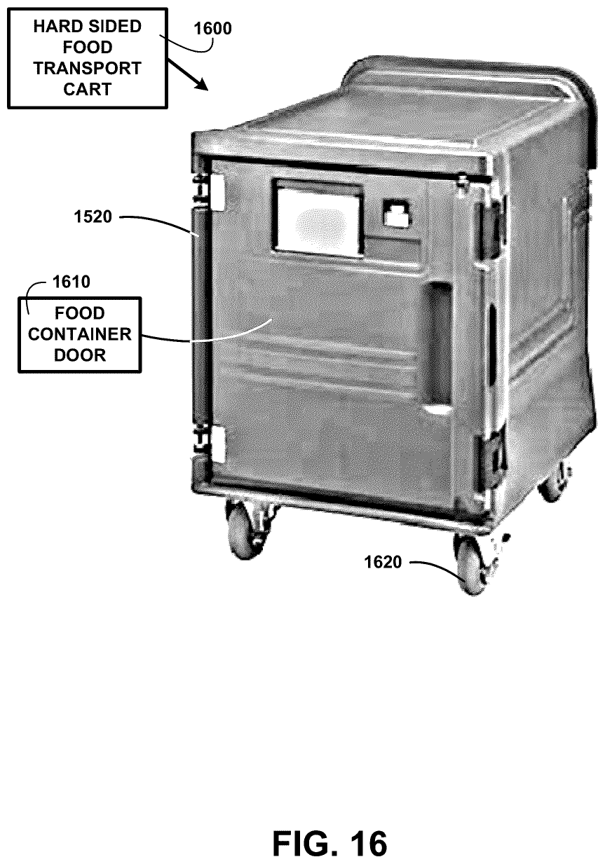

FIG. 16 shows for illustrative purposes only an example of a hard-sided food transport cart of one embodiment. FIG. 16 shows a hard-sided food transport cart 1600 with a food container door 1610. The heat module insert 1300 of FIG. 13 is placed along the sides of transport container 2100 of FIG. 21 and, in some embodiments; multiple units may be used in one transport container 2100 of FIG. 21. The hard-sided food transport cart 1600 is configured for transporting at least one transportable food warming module 1300 of FIG. 13 with the heater operating at a safe temperature for the food for delivery to a consumer. The hard-sided food transport cart 1600 rolls on a plurality of lockable casters 1620. In one embodiment the food container, cover, food container door include ultraviolet (UV) lights 1520 to treat the food to kill bacteria, viruses and other food borne pathogens and sterilize the food before, during and after the warming processes of one embodiment.

### Battery Box:

FIG. 17 shows for illustrative purposes only an example of a battery box of one embodiment. FIG. 17 shows a battery box 1420 for inserting a battery 1310 of FIG. 13 to supply power to the heat module insert 1300 of FIG. 13. The battery box 1420 includes a waterproof power button 1330 with a waterproof LED display 1340 to display the battery 1310 of FIG. 13 charge level. The battery 1310 of FIG. 13 is installed directly into the battery box 1420 with an O-ring waterproof seal to protect against spillage. The heat module insert 1300 of FIG. 13 has an integrated battery box and back support 1320 of FIG. 13 which is the primary structural support element for attachment of the rest of the modules and components. The battery box 1420 includes a control printed circuit board assembly (PCBA) configured for an internal master PCBA 1700 installed in the base of battery box 1420. When the system is activated the electrical power flows though the internal master PCBA 1700 and is converted to heat which is then distributed along the heat plate 1440 of FIG. 14 or other conductors that distribute heat into the food transport container 2100 of FIG. 21. The internal master PCBA 1700 also distributes power to other components for their operations. The rechargeable battery pack 400 of FIG. 4 is directly connected to the internal master PCBA 1700, installed in the base of battery box 1420.

### Battery Electrical Connections:

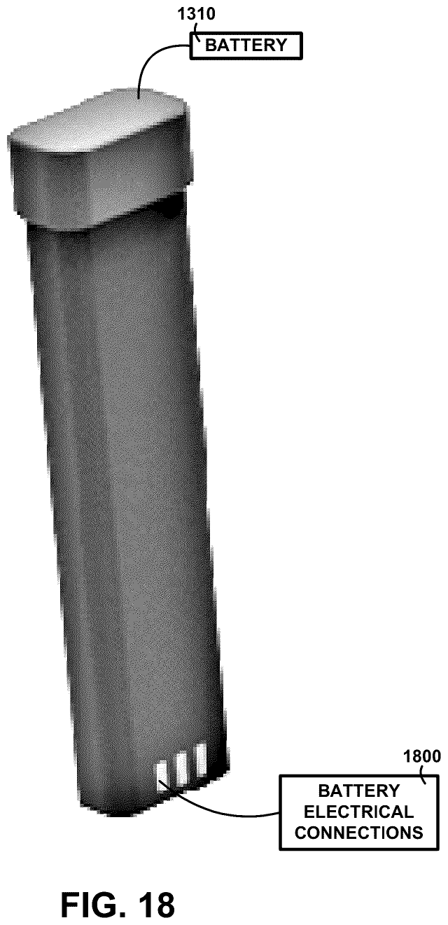

FIG. 18 shows for illustrative purposes only an example of battery electrical connections of one embodiment. FIG. 18 shows the battery 1310 and the battery electrical connections 1800 that feed power to the internal master PCBA 1700 of FIG. 17 of one embodiment.

### Temperature Control:

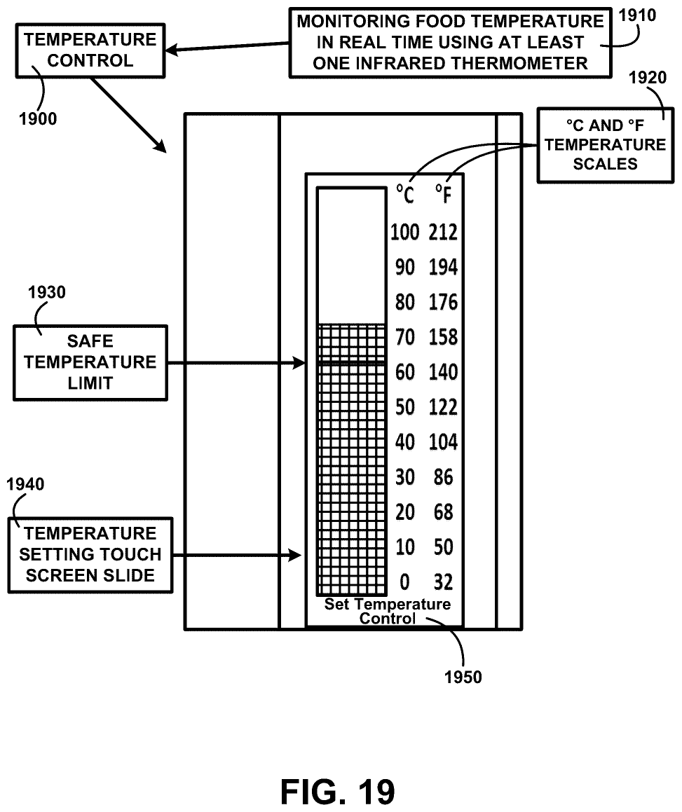

FIG. 19 shows for illustrative purposes only an example of a temperature control of one embodiment. FIG. 19 shows a temperature control 1900 panel display showing the current temperature and allows a user to adjust the temperature. The temperature control 1900 is also used for monitoring food temperature in real time using at least one no contact infrared thermometer 1910. The temperature control 1900 displays both ° C. and ° F. temperature scales 1920 and a safe temperature limit 1930. The temperature control 1900 includes a temperature setting touch screen slide 1940 for a user to set temperature control 1950 temperatures. In another embodiment the temperature control 1900 includes digital touch buttons labeled for specific food types for example soups, sandwiches, stews, vegetables, and others.

The digital touch buttons labeled for specific food types when pressed will set the targeted temperature setting to preset temperatures prerecorded in one of at least one databases. The temperature control 1900 is coupled to the control printed circuit board assembly. The temperature control 1900 is configured for the user to set a temperature for warming the food placed in the food warming system. The temperature setting touch screen slide 1940 is adjustable using degrees Celsius and degrees Fahrenheit temperature scales of one embodiment.

The temperature control is coupled to the control printed circuit board assembly (PCBA) 1700 of FIG. 17. The temperature control is configured for the user to set a temperature for warming the food placed in the food warming system. The temperature control includes a temperature setting touch screen slide adjusting feature. The temperature setting touch screen slide is adjustable using degrees Celsius and degrees Fahrenheit temperature scales. The temperature control includes monitoring food temperature in real-time using at least one infrared thermometer that is coupled to the control printed circuit board assembly (PCBA) 1700 of FIG. 17 and temperature control. The temperature setting touch screen slide includes a safe temperature limit indicating line to remind the user not to set a temperature above that limit. In another embodiment the temperature control includes digital touch buttons labeled for specific food types for example soups, sandwiches, stews, vegetables, and others. The digital touch buttons labeled for specific food types when pressed will set the targeted temperature setting to preset temperatures prerecorded in one of the at least one databases of one embodiment.

### Food Warming System Digital Application:

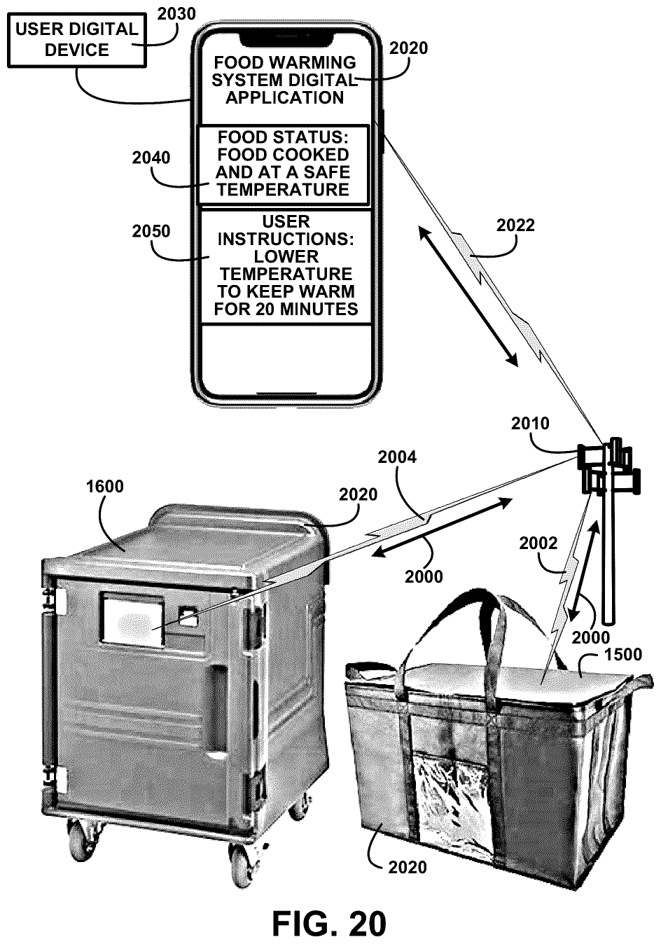

FIG. 20 shows for illustrative purposes only an example of a food warming system digital application of one embodiment. FIG. 20 shows transmitting food status information to a user and receiving user instructions from a user digital device 2030 using a food warming system digital application 2020. The soft-sided food transport container 1500 temperature control system is coupled to the food warming system digital application 2020 installed in the internal master PCBA 1700 of FIG. 17. The hard-sided rolling food transport container 1600 temperature control system is coupled to the food warming system digital application 2020 installed in the internal master PCBA 1700 of FIG. 17. The food warming system bidirectional communication 2000 allows food warming system digital application 2020 transmissions for example to a cell tower 2010, Bluetooth and WIFI connection to a user digital device 2030.

The food warming system digital application 2020 includes food warming system digital application bidirectional communication 2022. The food warming system digital application 2020 installed on the user digital device 2030 will display a food status: food cooked and at a safe temperature 2040. The user can transmit 2002 to the soft-sided rolling food transport container 1500 temperature control system user instructions and receive food status audible and visual alert broadcast from the soft-sided rolling food transport container 1500. The user can transmit 2004 to the hard-sided rolling food transport container 1600 temperature control system user instructions and receive food status audible and visual alert broadcast from the hard-sided rolling food transport container 1600. In one instance the user instructions can be to lower temperature to keep warm for 20 minutes 2050 before they arrive to the food transport container 2100 of FIG. 21 of one embodiment.

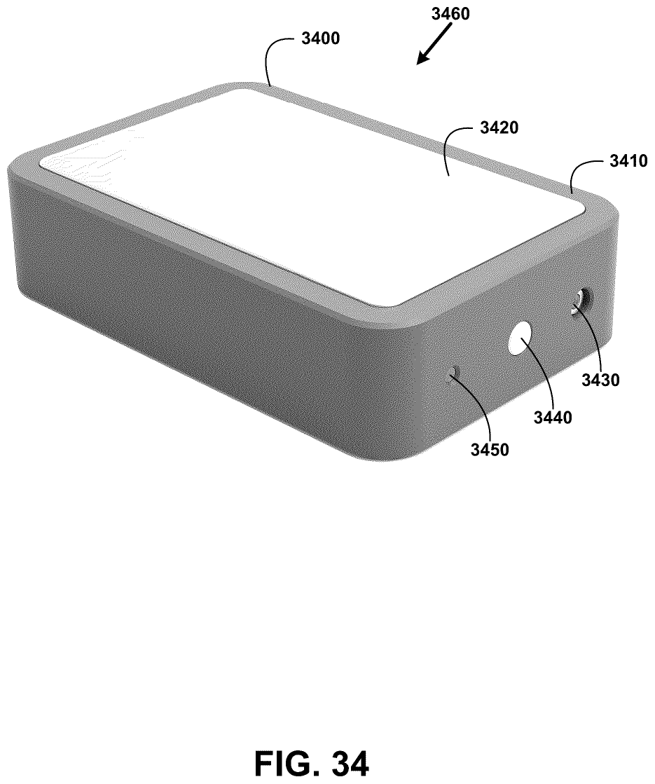

The food system heat module includes a food warming system digital application for installing on a user's digital device including for example a smart phone, tablet, laptop computer and other digital devices. The food warming digital application installed on a user's digital device is configured for displaying the food status alerts on a digital screen and broadcasting audible food status alerts. The user can tap the food warming digital application icon and receive intermediate food status alerts to check the current temperature and a calculated approximate time remaining for the food to reach a safe temperature. In one embodiment the food warming digital application may display the temperature selection controls of the chafer transportable food warming module 3460 of FIG. 34. This allows the user to set the desired temperature using the user's digital device. The user may want to turn off or adjust the temperature which they can perform using the food warming digital application of one embodiment.

A Food and Beverage Transport Container with Handles Down:

FIG. 21 shows for illustrative purposes only an example of a food and beverage transport container 2100 with handles down of one embodiment. FIG. 21 shows a food and beverage transport container 2100 is a caddy for carrying coffee cups, hot and cold beverages or sandwiches and muffins. The food and beverage transport container port container 2100 is herein also referred to interchangeably as a transport box. The main box body 2110 includes as shown folding handles 2120 in a down position and a caddy cover 2130 to remove to load the beverages in the multiple hot and cold beverage cup holder recesses which provide hot or cold temperature maintenance and prevent them from tipping over.

Applications provide a light weight heated or cooled transport for take-out coffees, teas, soft drinks and other types of beverages and food from coffee houses, restaurants or even user home brewed beverages for a picnic or other outing. The temperatures can be set to maintain a hot beverage drinkable temperature or in the case of soft drinks cooler temperatures of one embodiment.

The food and beverage container may be configured in shapes and sizes for various container types and sizes. For example, one shape and size for a portable beverage heating unit, in another example a portable food heating system. Another shape and size is a larger countertop unit. In other embodiments the food and beverage transport container 2100 devices may be configured to hold ice for keeping beverages cold. The folding handles 2120 allow an easy and space saving method to carry the Transport Box.

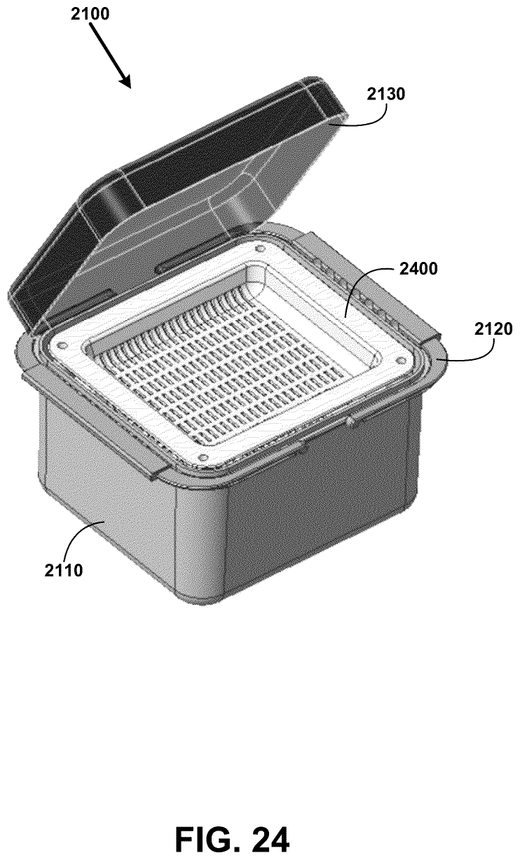

The food and beverage transport container 2100 is a portable device for maintaining hot food temperature inside a food transport container 2100. The folding handles 2120 allow an easy and space saving method to carry the transport box. A food and beverage transport container 2100 with an opaque folding cover. Other embodiments may have an insulated cover. The stackable food tray insert 2400 of FIG. 24 is installed into the main box body. The food and beverage transport container 2100 is a portable and interchangeable heating device.

The food and beverage transport container 2100 has an integrated battery box 1420 of FIG. 14. Battery pack is installed directly into battery box 1420 of FIG. 14 with a waterproof seal to protect against spillage. A heat plate 1440 of FIG. 14 is integrated inside the main body and contains the elements for heating food and beverage transport container 2100. A rechargeable battery pack 400 of FIG. 4 provides power to operate the system. The rechargeable battery pack 400 of FIG. 4 is directly connected to a control printed circuit board assembly (PCBA) 1700 of FIG. 17, installed in the base of main box body, which controls power flow, temperature, charging and all battery safety protocols. When the system is activated, electrical power flows though the PCBA 1700 of FIG. 17 and is converted to heat which is then distributed along the heat plate 1440 of FIG. 14 or other conductors that distribute heat into the transport container 2100.

A series of LED indicators are also connected to the PCBA 1700 of FIG. 17 and show a power level of the rechargeable battery pack 400 of FIG. 4. Charging the rechargeable battery pack 400 of FIG. 4 is accomplished via a separate battery charge unit. Entire device is placed in charging base for auto recharge. The food and beverage transport container 2100 forms a self-contained, lightweight, compact, battery powered device with heat elements, adaptable to hot food and beverage or cold beverage transport. The exterior plastic main box may be fabricated using plastic injection, blow molding or roto molding providing low cost and scalable manufacturing systems.

A Food and Beverage Transport Container with Handles Up:

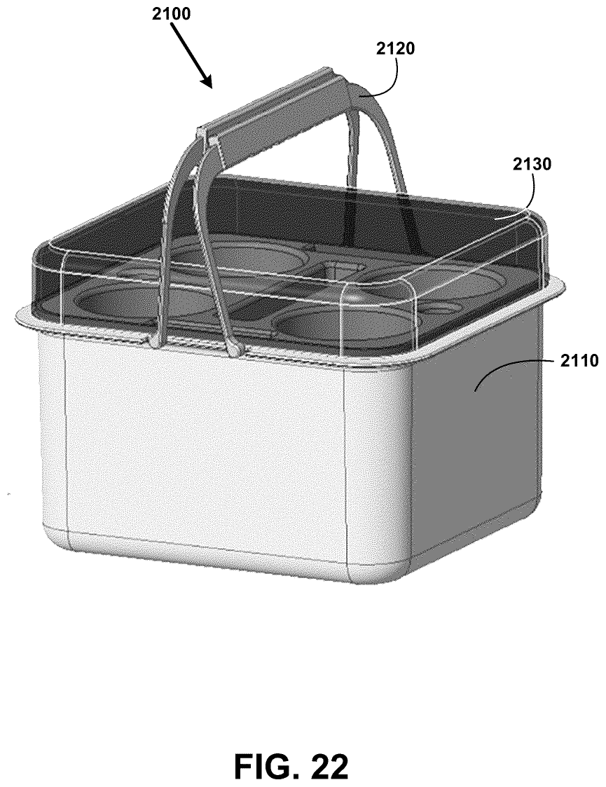

FIG. 22 shows for illustrative purposes only an example of a food and beverage transport container with handles up of one embodiment. FIG. 22 shows the food and beverage transport container 2100, main box body 2110 with the folding handles 2120 in an up position. The food and beverage transport container 2100 cover 2130 is hinged for easy access. In one embodiment the beverage cup holder may include a heating element to transfer heat directly to the aluminum cup holders. In another embodiment, ice can be inserted to surround the aluminum cup holders and provide beverage cooling.

In one embodiment the food and beverage transport container is a transport container for maintaining predetermined temperatures of human consumables during transport. A transport container configured for maintaining predetermined temperatures of human consumables for transport to a consumer. A plurality of aluminum holders coupled to the transport container configured to hold related human consumable containers. A continuous heat plate coupled to each aluminum holder configured to transfer heat at predetermined temperatures to the related human consumable containers. Wherein the continuous heat plate is configured to be activated automatically when a human consumable container is inserted into an aluminum holder.

An electronic control board coupled to the continuous heat plate configured for controlling power flow, temperature, charging and all battery safety protocols. An aluminum protect plate coupled to the continuous heat plate configured for transferring heat directly into the plurality of aluminum holders. A waterproof seal coupled to the aluminum protect plate configured to prevent spillage into an electronic compartment below and aid in cleaning. Wherein the plurality of aluminum holders are adjacent to the top surface of the aluminum protect plate configured for transferring heat into human consumable container liquids. Wherein the plurality of aluminum holders are configured to maintain cooled human consumables temperatures with ice deposited into the transport container. A rechargeable battery pack coupled to the electronic control board configured to power the continuous heat plate to maintain predetermined temperatures of the plurality of aluminum holders human consumable container liquids of one embodiment.

A Food and Beverage Transport Container with the Cover Up:

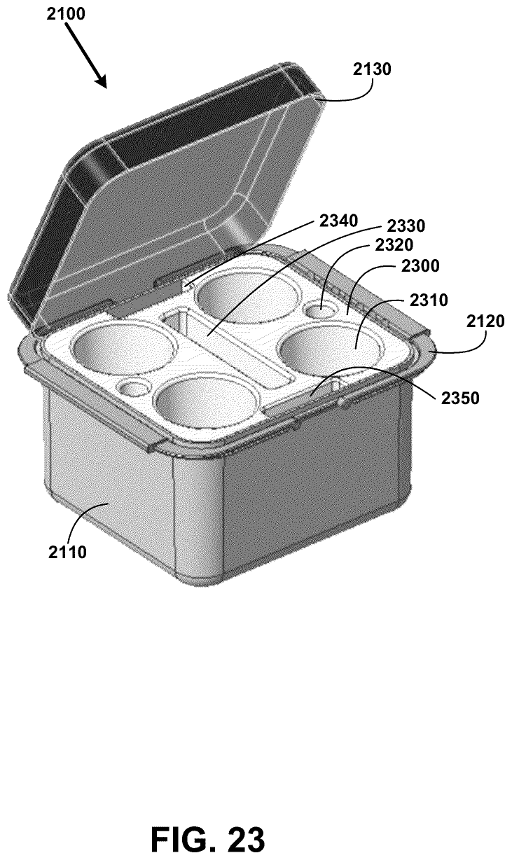

FIG. 23 shows for illustrative purposes only an example of a food and beverage transport container with the cover up of one embodiment. FIG. 23 shows a food and beverage transport container 2100 with an opaque folding cover 2130. Other embodiments may have an insulated cover. The Removable Cup Holder Insert 2300 is installed into the Main Box Body 2110. The Removable Cup Holder Insert 2300 includes at least one convenient accessory holder including aluminum cup holders 2310 for improved heat or cold transfer into cup holder, stir stick holder 2320, sugar/cream holder 2330, cup sleeve holder 2340, and napkin holder 2350. The main box body 2110 has attached the folding handles 2120.

### A Stackable Food Tray Insert:

FIG. 24 shows for illustrative purposes only an example of a stackable food tray insert of one embodiment. FIG. 24 shows a food and beverage transport container 2100 with an opaque folding cover 2130 and folding handles 2120 of one embodiment. Other embodiments may have an insulated cover. The stackable food tray insert 2400 is installed into the main box body 2110. The food and beverage transport container 2100 is a portable and interchangeable heating device.

### Food and Beverage Transport Container Components:

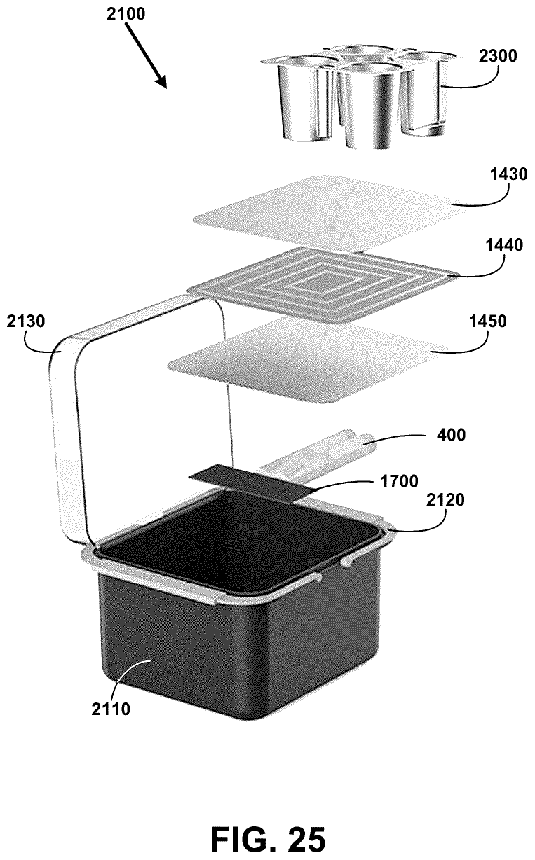

FIG. 25 shows for illustrative purposes only an example of food and beverage transport container components of one embodiment. FIG. 25 shows the food and beverage transport container components including main box body 2110, opaque folding cover 2130, folding handles 2120, and aluminum protect plate 1430, heat plate 1440, insulating pad 1450, rechargeable battery pack 400, PCBA 1700, and removable cup holder insert 2300.

The food and beverage transport container 2100 has an integrated battery box 1420 of FIG. 14. A battery pack is installed directly into battery box 1420 of FIG. 14 with a waterproof seal to protect against spillage. A heat plate 1440 is integrated inside the main body and contains the elements for heating food and beverage transport container 2100. A rechargeable battery pack 400 provides power to operate the system of one embodiment.

The rechargeable battery pack 400 is directly connected to a control printed circuit board assembly (PCBA) 1700, installed in the base of main box body 2110, which controls power flow, temperature, charging and all battery safety protocols. An auto on system is also connected to the PCBA 1700 and is used to activate the system when removed from charging base. When the system is activated, electrical power flows though the PCBA 1700 and is converted to heat which is then distributed along the heat plate 1440 or other conductors that distribute heat into the transport container. A series of LED indicators are also connected to the PCBA 1700 and show a power level of the rechargeable battery pack 400. Charging the rechargeable battery pack 400 is accomplished via a separate battery charge unit. Entire device is placed in Charging Base for Auto Recharge

The food and beverage transport container 2100 forms a self-contained, lightweight, compact, battery powered device with heat elements, adaptable to hot food and beverage or cold beverage transport. The exterior plastic Main Box may be fabricated using plastic injection, Blow Molding or Roto Molding providing low cost and scalable manufacturing systems of one embodiment.

The removable cup holder insert which is constructed of aluminum cup holders mounted in a plastic tray. The bottom of the aluminum cup holders rest directly on the surface of the Aluminum protect plate 1430, thereby transferring heat directly into the cup holder. Beverage cups filled with Hot Beverages are inserted in the cup holders and the transferred heat maintains hot temperature of liquid. The Aluminum protect plate 1430 is highly heat conductive and transfers heat directly to cup holders while also protecting the Heat plate 1440. The Aluminum protect plate 1430 has a waterproof O-ring seal to prevent spillage into the electronic compartment below and aid in cleaning. The Heat plate 1440 is attached directly to the Aluminum Protective Plate for maximum heat transfer. The Insulation Pad provides heat protection for the batteries and PCBA 1700. The PCBA 1700 is connected directly to the Heat plate 1440 to control and maintain heating temperature. The battery Pack is connected directly to PCBA 1700 and provides the energy which PCBA 1700 transfers to Heat plate 1440 to create thermo electric heat of one embodiment.

The PCBA 1700 is connected directly to the heat plate 1440 to control and maintain heating temperature. The battery pack is connected directly to PCBA 1700 and provides the energy which PCBA 1700 transfers to heat plate 1440 to create thermo electric heat of one embodiment. The plastic tray includes storage spaces for stir sticks, sugar and cream, napkin holder, cup sleeve holder. Shows the stackable removable food tray inserts which are constructed of heat resistant, food safe plastic. The stackable removable food tray inserts sit above the surface of the Aluminum protect plate 1430, thereby absorbing heat into the food contents. The Aluminum protect plate 1430 is highly heat conductive and transfers heat directly to the air space around food trays while also protecting the heat plate 1440.

The heat plate 1440 is attached directly to the aluminum protective plate for maximum heat transfer. The insulation pad provides heat protection for the batteries and PCBA 1700. The PCBA 1700 is connected directly to the heat plate 1440 to control and maintain heating temperature. Power is supplied by a customized rechargeable battery pack 400. Heating power, charging and battery safety circuits are all contained in the PCBA 1700. The heat elements transfer heat into the transport container to keep food and beverages warm.

In one embodiment a rechargeable battery pack 400 provides power to operate the heat module insert 1300 of FIG. 13. At least one battery 1310 of FIG. 13 can be inserted into the accessory multi-unit battery charger 1400 of FIG. 14 with an AC adapter cord 1404 of FIG. 14 for recharging at least one battery 1310 of FIG. 13 of the rechargeable battery pack 400. The rechargeable battery pack 400 may include for example a lithium ion rechargeable battery pack 400, lithium polymer (LiPo) rechargeable battery, rechargeable aluminum-based batteries, rechargeable nickel-iron battery and other rechargeable battery types. The internal master PCBA 1700 of FIG. 17 may include a plurality of printed circuits configured for differing functions including electronic components and circuits for controlling the various heat module insert 1300 of FIG. 13 system operations as described above and in the following descriptions. The internal master PCBA 1700 of FIG. 17 includes multiple safety systems for battery charging and operation of one embodiment.

The heat module insert 1300 of FIG. 13 includes a food warming system digital application for installing on a user's digital device including for example a smart phone, tablet, laptop computer and other digital devices. The food warming system digital application installed on a user's digital device is configured for displaying the food status alerts on a digital screen and broadcasting audible food status alerts. The user can tap the food warming system digital application icon and receive intermediate food status alerts to check the current temperature and a calculated approximate time remaining for the food to reach a safe temperature.

In one embodiment the food warming system digital application may display the temperature selection controls of the food warming food container. This allows the user to set the desired temperature using the user's digital device. The user may want to turn off or adjust the temperature which they can perform using the food warming system digital application of one embodiment.

### Removable Cup Holder Insert:

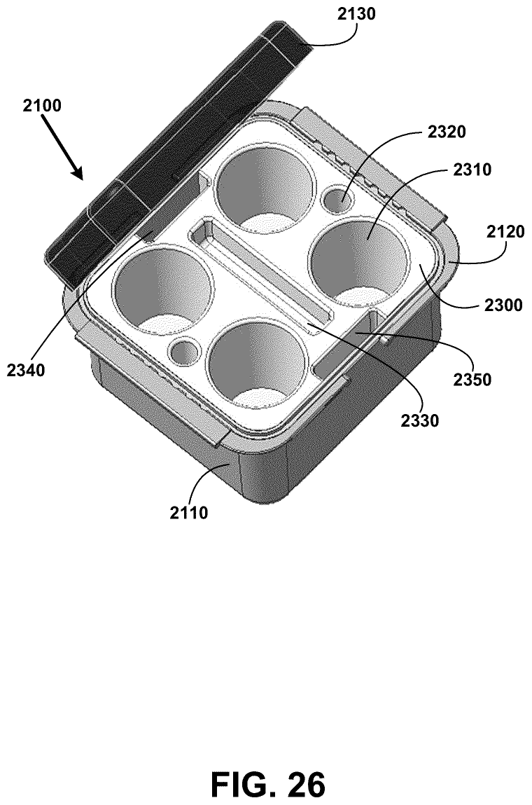

FIG. 26 shows for illustrative purposes only an example of a top view of removable cup holder insert of one embodiment. FIG. 26 shows the Removable cup Holder Insert 2300 which is constructed of aluminum cup holders 2310 mounted in a plastic tray. the Removable cup Holder Insert 2300 is installed in the main box body 2110. The food and beverage transport container 2100 includes the main box body 2110 with the caddy cover 2130, and folding handles 2120. The Plastic tray includes storage spaces for stir stick holder 2320, sugar/cream holder 2330, cup sleeve holder 2340, and napkin holder 2350.

### Stackable Food Tray Container Components:

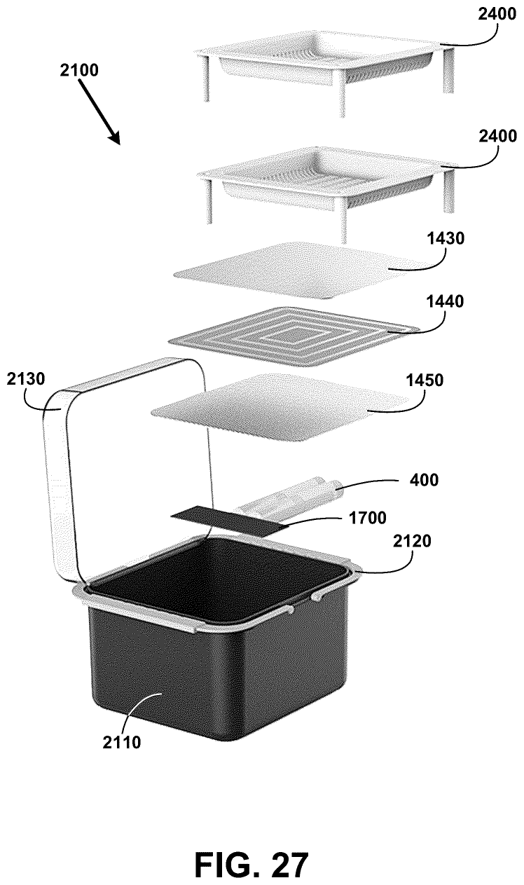

FIG. 27 shows for illustrative purposes only an example of an exploded view of food and beverage transport container stackable food tray components of one embodiment. FIG. 27 shows the Stackable Removable Food Tray Inserts 2400 which are constructed of heat resistant, food safe plastic. The Stackable Removable Food Tray Inserts 2400 sit in the main box body 2110 above the surface of the Aluminum protect plate 1430, thereby absorbing heat into the food contents. The food and beverage transport container includes the caddy cover 2130, folding handles 2120 coupled to the main box body 2110.

The Aluminum Protect Plate 1430 is highly heat conductive and transfers heat directly to the air space around Food Trays while also protecting the Heat Plate 1440. The Aluminum Protect Plate 1430 has a waterproof O-ring seal to prevent spillage into the electronic compartment below and aid in cleaning. The Heat Plate 1440 is attached directly to the Aluminum Protective Plate 1430 for maximum heat transfer. The Insulation Pad 1450 provides heat protection for the batteries and PCBA 1700. The PCBA 1700 is connected directly to the Heat Plate 1440 to control and maintain heating temperature. The rechargeable battery pack 400 is connected directly to PCBA 1700 and provides the energy which PCBA 1700 transfers to Heat Plate 1440 to create thermo electric heat of one embodiment.

The food and beverage transport container 2100 is configured to be easily portable so that food and beverages can be warmed in multiple diverse and varying transport situations. The food and beverage transport container 2100 devices are self-contained, food safe and waterproof so that liquidus spillage will not damage the system. Power is supplied by a customized rechargeable battery pack 400. Heating power, charging and battery safety circuits are all contained in the PCBA 1700. When the system is activated the PCBA 1700 will convert electrical energy to heat energy and disperse it through conductors including for example the heat plate 1440 or other conductors of one embodiment. The heat elements transfer heat into the transport container to keep food and beverages warm.

Folding Handles 2120

### Cold Drink Transporter:

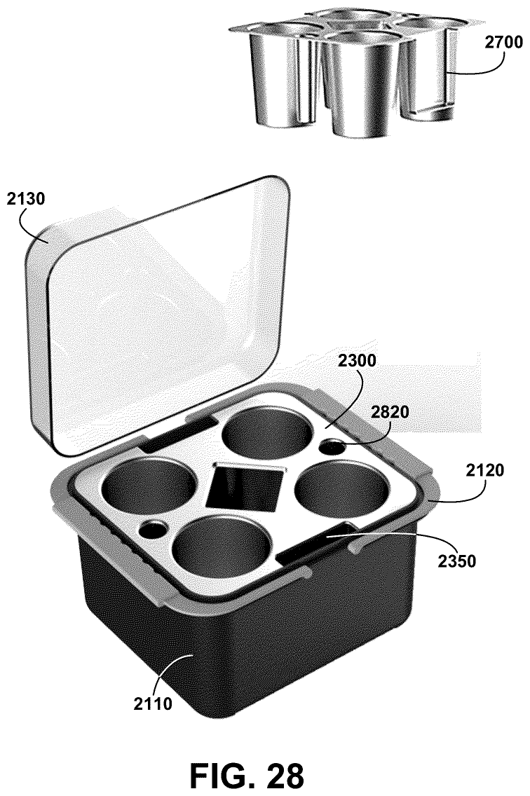

FIG. 28 shows for illustrative purposes only an example of a top view of cold drink transporter. FIG. 28 shows the removable cup holder insert 2300 which is constructed of aluminum cup holders 2700 mounted in a plastic tray. The cold drink transporter includes the caddy cover 2130, folding handles 2120 coupled to the main box body 2110. The Plastic tray includes storage spaces for Straws 2820, and Napkin Holder 2350, and an ice input opening. Ice is poured directly in the center diamond shaped opening thereby surrounding the aluminum cup holders and keeping beverages cold.

### Countertop Cup Heating Tray:

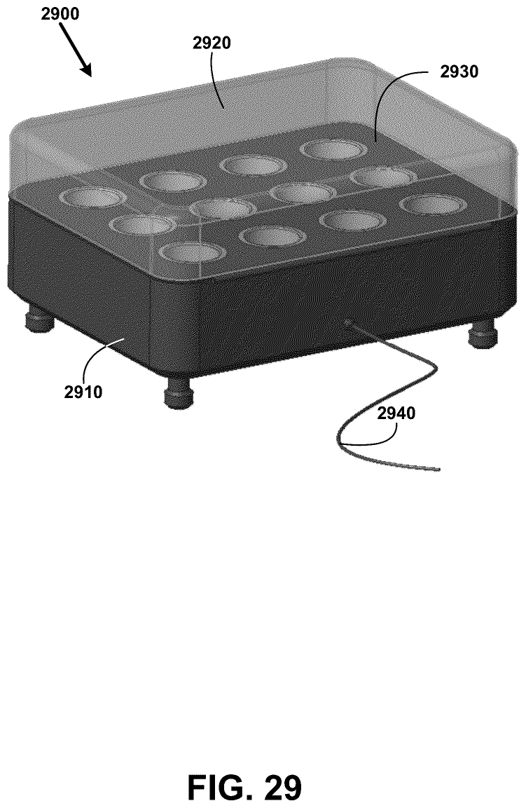

FIG. 29 shows for illustrative purposes only an example of a top view of a countertop cup heating tray. FIG. 29 shows an external power countertop cup heating tray 2900 with a clear cover 2920 of one embodiment. Other embodiments may incorporate an insulated cover. A removable aluminum cup holder insert 2930 is installed in the countertop base box 2910 with an external power cord 2940. An aluminum protect plate 1430 of FIG. 14 is coupled to a heat plate and configured for transferring heat directly into a plurality of aluminum cup holders. The aluminum cup holders rest directly on the top surface of the aluminum protect plate 1430 of FIG. 14 configured for transferring heat into a plurality of beverage cup liquids.

The external power countertop cup heating tray includes a clear cover. Other embodiments may incorporate an insulated cover. In another embodiment power may be provided with a rechargeable battery pack 400 of FIG. 4. Multiple aluminum cup holder inserts are installed in the countertop base box with an external power cord. External power countertop cup heating tray exploded view. The removable cup holder insert which is constructed of aluminum cup holders mounted in a plastic tray. The bottom of the aluminum cup holders rest directly on the surface of the Aluminum protect plate 1430 of FIG. 14, thereby transferring heat directly into the cup holder.

Beverage cups filled with hot beverages are inserted in the cup holders and the transferred heat maintains hot temperature of liquid. The Aluminum protect plate 1430 of FIG. 14 is highly heat conductive and transfers heat directly to cup holders while also protecting the heat plate 1440 of FIG. 14. The Aluminum protect plate 1430 of FIG. 14 has a waterproof O-ring seal to prevent spillage into the electronic compartment below and aid in cleaning. The heat plate 1440 of FIG. 14 is attached directly to the aluminum protective plate for maximum heat transfer. The insulation pad provides heat protection for the batteries and PCBA 1700 of FIG. 17.

The PCBA 1700 of FIG. 17 is connected directly to the heat plate 1440 of FIG. 14 to control and maintain heating temperature. The power converter is connected directly to PCBA 1700 of FIG. 17 and provides the energy which PCBA 1700 of FIG. 17 transfers to heat plate 1440 of FIG. 14 to create thermo-electric heat. The external power countertop cup heating tray has a continuous heat plate 1440 of FIG. 14 under all cup holders with a power on/off switch. In another embodiment, 4 heat strips under 3 cup holders each are activated automatically when a cup is inserted into any of the cup holders in that row. In yet another embodiment, each cup holder has its own individual heat tray 3400 of FIG. 34 which is activated automatically when a cup is inserted into holder.

### Countertop Cup Heating Tray Components:

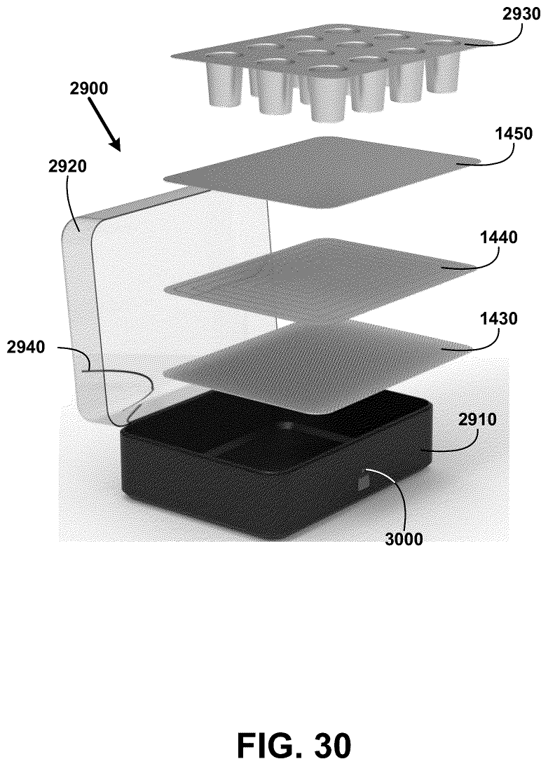

FIG. 30 shows for illustrative purposes only an example of an exploded top view of a countertop cup heating tray components of one embodiment. FIG. 30 shows for illustrative purposes only an example of external power countertop cup heating tray 2900 exploded view. FIG. 30 shows the aluminum cup holder insert 2930 which is constructed of aluminum cup holders mounted in a plastic tray. The bottom of the aluminum cup holders 2900 rest directly on the surface of the aluminum protect plate 1430, thereby transferring heat directly into the cup holder. Beverage cups filled with hot beverages are inserted in the cup holders and the transferred heat maintains hot temperature of liquid.

The external power countertop cup heating tray 2900 includes a clear cover 2920, an external power cord 2940, a countertop base box 2910 with a power indicator 3000. The Aluminum Protect Plate 1430 is highly heat conductive and transfers heat directly to cup holders while also protecting the Heat Plate 1440. The Aluminum Protect Plate 1430 has a waterproof O-ring seal to prevent spillage into the electronic compartment below and aid in cleaning. The Heat Plate 1440 is attached directly to the Aluminum Protective Plate 1430 for maximum heat transfer. The Insulation Pad 1450 provides heat protection for the batteries and PCBA 1700 of FIG. 17. The PCBA 1700 of FIG. 17 is connected directly to the Heat Plate 1440 to control and maintain heating temperature. The Power converter is connected directly to PCBA 1700 of FIG. 17 and provides the energy which the PCBA 1700 of FIG. 17 transfers to Heat Plate 1440 to create thermo-electric heat of one embodiment.

The External Power Countertop Cup Heating Tray 2900 has a continuous heat plate 1440 under all cup holders with a Power On/Off switch in one embodiment. In another embodiment, 4 heat strips under 3 cup holders each are activated automatically when a cup is inserted into any of the cup holders in that row. In yet another embodiment, each cup holder has its own individual heat tray 3400 of FIG. 34 which is activated automatically when a cup is inserted into holder.

The food and beverage container may be configured in shapes and sizes for various container types and sizes. For example, one shape and size for a portable beverage heating unit, in another example a portable food heating system. Another shape and size is a larger countertop unit. In other embodiments the food and beverage transport container 2100 of FIG. 21 devices may be configured to hold ice for keeping beverages cold.

Automatic multi-unit charging nest:

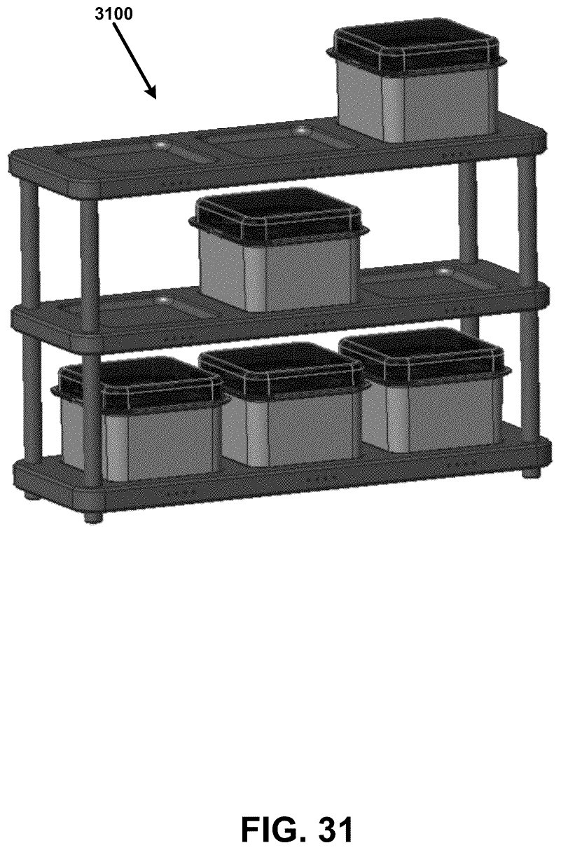

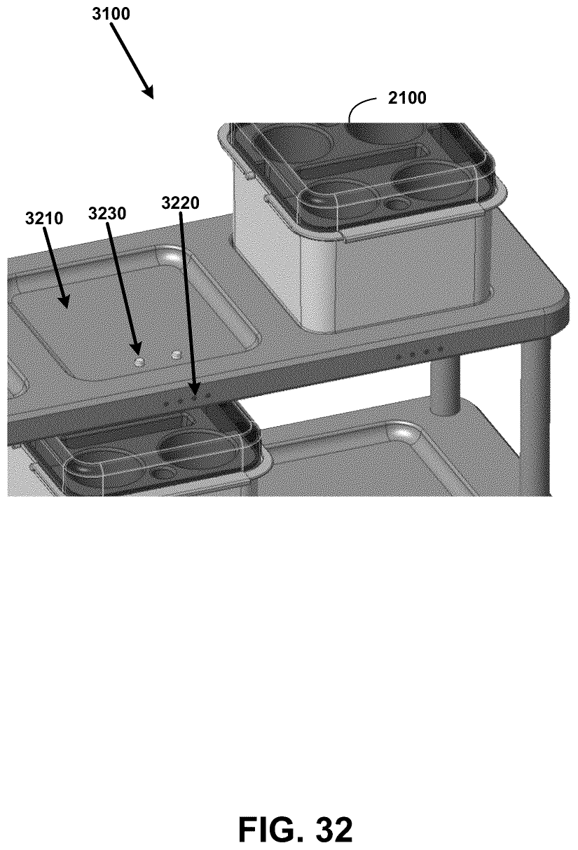

FIG. 31 shows for illustrative purposes only an overview example of an Automatic Multi-Unit Charging Nest with Transport Boxes installed for charging of one embodiment. FIG. 31 shows the multi-shelved Automatic Multi-Unit Charging Nest 3100 configured for charging a plurality of transport boxes simultaneously. The automatic multi-unit charging nest 3100 is configured for recharging a plurality of transport boxes simultaneously when installed. The charging nest includes a plurality of nesting cavities and charge level indicators. The automatic multi-unit charging nest 3100 is configured for simple and automated use, wherein placing a transport container in a nesting cavity 3210 of FIG. 32 aligns spring pins and automatically activates the charging process. When the charge process is complete, the nesting cavity 3210 of FIG. 32 will automatically switch to stand-by mode. Charge status is shown by the CHARGE LEVEL INDICATOR 3220 of FIG. 32. Removing a transport container from the automatic multi-unit charging nest 3100 will. Automatically turn the charging system off for that specific nesting cavity 3210 of FIG. 32. Automatically turn on the transport container.

### Charging Nest:

FIG. 32 shows for illustrative purposes only an example of a detailed view of charging nest 3100 with nesting cavity 3210 and charge level indicator 3220 of one embodiment. Shown on the nesting cavity 3210 are charging spring pins 3230 that correlate to positions of charging spring pins 3230 on the bottom of each transport container 2100 that conduct power into the transport box batteries. Seen on the front edge of the nesting cavity 3210 is a charge level indicator 3220.

### Charging Spring Pins:

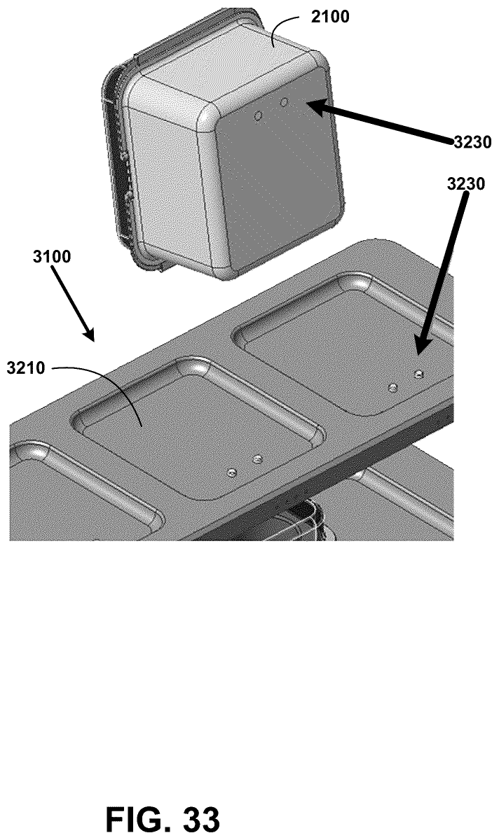

FIG. 33 shows for illustrative purposes only an example of a detailed view of Charging Nest with Charging Spring pin of one embodiment. The Automatic Multi-unit Charging Nest 3100 is designed for simple and automated use. Placing a Transport Container 2100 in Nesting Cavity 3210 aligns Spring Pins 3230 and automatically activates the charging process. When charge process is complete, the Nesting Cavity 3210 will automatically switch to stand-by mode. Charge status is shown by the Charge Level Indicator 3220 of FIG. 32. Removing a Transport container 2100 from Automatic Multi-unit Charging Nest 3100 will a) automatically turn charging system off for that specific Nesting Cavity 3210 and b) Automatically turn ON the Transport Container 2100.

### A Chafer Transportable Food Warming Module:

FIG. 34 shows for illustrative purposes only an example of a chafer transportable food warming module of one embodiment. FIG. 34 shows a chafer transportable food warming module 3460. The chafer transportable food warming module 3460 is a buffet line heating element. The chafer transportable food warming module 3460 is put underneath food dishes to keep the food in serving line warm. The chafer transportable food warming module 3460 includes a protective heating surface 3420 coupled to the main box container 3410 configured to produce heat and direct the heat to the bottom of a food container placed onto the protective heating surface 3420 for heating the food. The chafer transportable food warming module 3460 can be powered by battery or AC power. The chafer transportable food warming module 3460 replaces the noxious sterno can. The chafer transportable food warming module 3460 is also referred to herein interchangeably without change in meaning to as a heat tray 3400.

A heat tray 3400 includes a main box container 3410 with a protective heating surface 3420. A charging port 3430 is available for recharging batteries in the heat tray 3400 to maintain the heat and temperature settings for the food being served. A power button 3440 configured for turning on and off the heating and a power indicator light 3450 showing when the heat is on or off. The chafer transportable food warming module 3460 applications replace other typical buffet line heating methods which might pose a fire hazard, fluctuating temperatures, obnoxious fumes. The chafer transportable food warming module 3460 additionally provides temperature controls to maintain safe food temperatures. The temperature controls for each chafer transportable food warming module 3460 are adjustable using the food warming system digital application 2020 of FIG. 20 on a user digital device 2030 of FIG. 20 of one embodiment.

The chafer transportable food warming module 3460 includes a control printed circuit board assembly (PCBA) 1700 of FIG. 17 coupled to the battery box 1420 of FIG. 14 and is also referred to herein interchangeably without any change in meaning as an internal master PCBA 1700. The control printed circuit board assembly (PCBA) 1700 of FIG. 17 is electrically coupled to the rechargeable battery. The control printed circuit board assembly (PCBA) 1700 is coupled to a battery charge level device. The control printed circuit board assembly (PCBA) 1700 of FIG. 17 is coupled to an infrared thermometer sensor for monitoring food temperature in real time.

The control printed circuit board assembly (PCBA) 1700 of FIG. 17 includes at least one digital processor, at least one digital memory device, at least one database; at least one infrared thermometer coupled to the PCBA 1700 of FIG. 17, at least one chemical vapor sensing device, at least one circuit coupled to the food container cover, at least one circuit coupled to at least one digital temperature display, at least one circuit coupled to an alert light coupled to the cover, and at least one circuit coupled to a temperature control selection device mounted on the heat tray 3400. The at least one chemical vapor sensing device is used to analyze odors from the food placed in the heat tray 3400.

At least one chemical vapor sensing device detects the chemical signatures of spoiled food odors, food borne pathogens for example salmonella and other food conditions that may cause a food consumer to become ill or even die. The chemical vapor sensing device coupled to the control printed circuit board assembly (PCBA) 1700 of FIG. 17 performs the chemical analysis to determine the chemical formulae of the vapor elements of one embodiment.

At least one digital processor is used to search at least one digital memory device database for the identity of the chemical formulae from the chemical compound data prerecorded and stored in that database. Should the identified chemical formulae be a categorized as a health hazard, the PCBA 1700 of FIG. 17 will transmit an alert to the user to dispose of the food and not eat the food and identifying the potential health hazard detected. Embodiments may include using the at least one digital memory device database for recording data on various food stuffs to include, characteristics, visual examples, minimum food safety temperatures, precautions, spoilage indications and signs, and other information for keeping foods safe for consumption. In another embodiment the identified chemical formulae is transmitted to a food warming system digital application on a user's digital device.

The food warming system digital application is configured to perform an internet search for information to determine if the identified chemical formulae are categorized as a health hazard. The food warming system digital application will automatically display a visual warning and broadcast an audible alert to the user regarding the potential health hazard that has been determined. In another embodiment the user may enter the type of food to be placed in the food transport system digital application installed on the user's digital device.

The food warming system digital application will perform a search and display, characteristics, visual examples, minimum food safety temperatures, precautions, spoilage indications and signs, and other information for keeping foods safe for consumption. The control printed circuit board assembly (PCBA) 1700 includes at least one cellular connectivity device and transceiver for transmitting food status signal alerts, battery charge alerts and receiving user turn-off instructions. The control printed circuit board assembly (PCBA) 1700 of FIG. 17 includes connectivity devices to Bluetooth and WI-FI to provide communication and control alternatives to the user including voice activated commands.

A rheostat device for regulating power levels conducting battery energy to a plurality of heat dispensing elements is also controlled by the control printed circuit board assembly (PCBA) 1700 of FIG. 17. The rechargeable battery provides power to operate the food warming system components. The control printed circuit board assembly (PCBA) 1700 of FIG. 17 controls power flow, temperature, charging and all battery safety protocols. The waterproof power button is also coupled to the control printed circuit board assembly (PCBA) 1700 of FIG. 17 and rechargeable battery and is used to activate the system. When the system is activated, electrical power flows though PCBA 1700 of FIG. 17 and is converted to heat which is then distributed along the heat plate 1440 of FIG. 14 of one embodiment.

The chafer transportable food warming module is an electric chafer transportable food warming module for heating food in a food container. The electric chafer transportable food warming module with an electric heat generating plate is coupled to a protective heating surface for heating food in a food container to predetermined temperatures. The protective heating surface is configured to direct the heat to the bottom of the food container adjacent to the protective heating surface for heating the food. The electric chafer transportable food warming module includes a battery pack coupled to the electric heat generating plate configured for powering the electric heat generating plate.

A frame insulating connective plate coupled to the battery pack configured to insulate the battery pack from the heat generating plate. A main box bottom with a battery compartment coupled to the frame insulating connective plate configured to contain the battery pack. An electronic temperature control device coupled to the electric heat generating plate configured to regulate temperatures produced by the electric heat generating plate to maintain predetermined food temperatures while the food is being served. A temperature setting touch screen slide coupled to the electronic temperature control configured to include digital touch buttons labeled for a plurality of specific food types when pressed will set a preset targeted temperature setting prerecorded in at least one database for the specific food type of one embodiment.

### Chafer Transportable Food Warming Module Components:

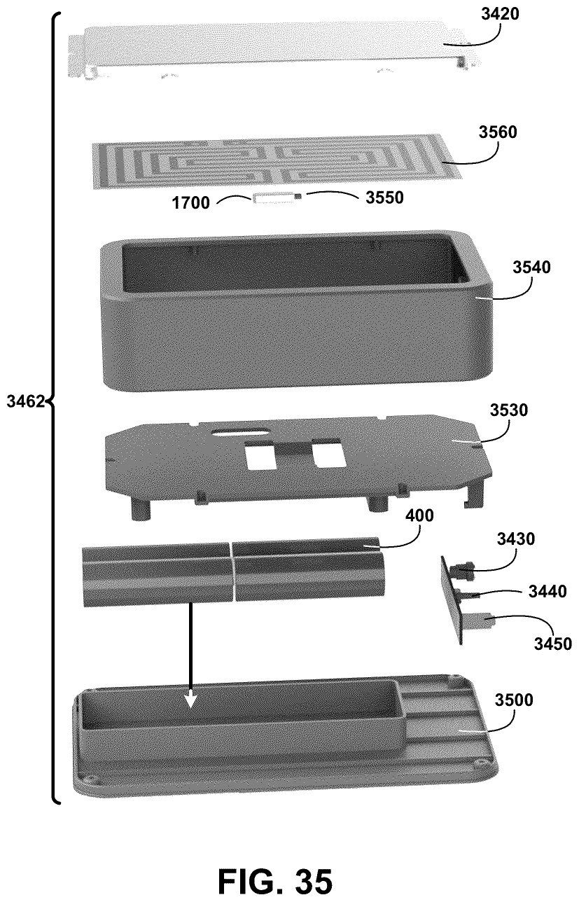

FIG. 35 shows for illustrative purposes only an example of chafer transportable food warming module components of one embodiment. FIG. 35 shows chafer transportable food warming module components 3462 housed within a main box container 3540. The components include a main box bottom with battery compartment 3500, charging port 3430, power button 3440, power indicator light 3450, rechargeable battery pack 400, frame insulating connective plate 3530, internal master PCBA 1700, electrical connector 3550, heat generating plate 3560, and protective heating surface 3420. In one embodiment, the chafer transportable food warming module is not transportable and is a buffet warmer. The buffet warmer is set in the buffet line to warm buffet dishes. The buffet warmer is configured to warm soup tureens, cast iron trays, and porcelain dish containers of one embodiment.

A rechargeable battery pack 400 may include for example a lithium ion rechargeable battery pack, lithium polymer (LiPo) rechargeable battery, rechargeable aluminum-based batteries, rechargeable nickel-iron battery and other rechargeable battery types. The control printed circuit board assembly (PCBA) 1700 may include a plurality of printed circuits configured for differing functions including electronic components and circuits for controlling the various food warming system operations as described above and in the following descriptions. The control printed circuit board assembly (PCBA) 1700 includes multiple safety systems for battery charging and operation of one embodiment.

### A Small Pizza Delivery Bag:

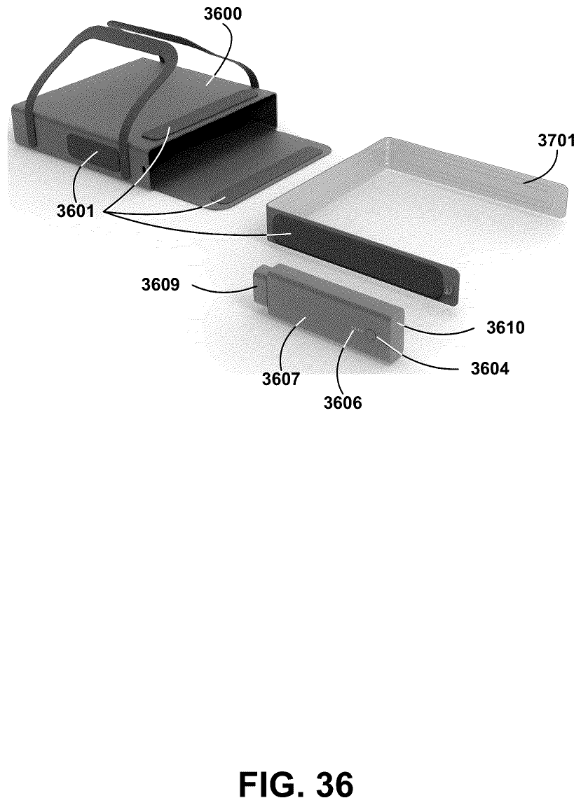

FIG. 36 shows for illustrative purposes only an example of an overview of a small pizza delivery bag of one embodiment. FIG. 36 shows a small pizza delivery bag 3600 including a food transport warming system comprising a heat assembly insert 3701 with a battery 3609, battery box 3607, waterproof power button 3604, and waterproof LED display 3606. The food system heat assembly insert 3701 is a portable device for maintaining hot food temperature inside a small pizza delivery bag 3600. The food system heat assembly insert 3701 is a portable and interchangeable heating device. The food system heat assembly insert 3701 has an attachable battery box. A battery 3609 is installed directly into the battery box with an O-ring waterproof seal to protect against spillage.

In one embodiment a rechargeable battery pack 1310 of FIG. 18 provides power to operate the warming device with a PCBA 3610 of one embodiment. The heat assembly insert 3701 is placed along the sides of a small pizza delivery bag 3600 and, in some embodiments.

Multiple units may be used in one a small pizza delivery bag 3600. The heat elements transfer heat into the small pizza delivery bag 3600 to help keep food warm. The small pizza delivery bag systems are attached to the inner surface of the small pizza delivery bag 3600 with Velcro 3601 in one embodiment. Other embodiments could include brackets, clips, or other attachment systems. The small pizza delivery bag system forms a lightweight, compact, battery powered, food safe, device with heat elements, adaptable to virtually any small pizza delivery bag type. The exterior plastic parts may be fabricated using plastic injection, co molded silicone injection, Surface Mount (SMT) assembly providing low cost and scalable manufacturing systems of one embodiment.

### Heat Plate Assembly Insert:

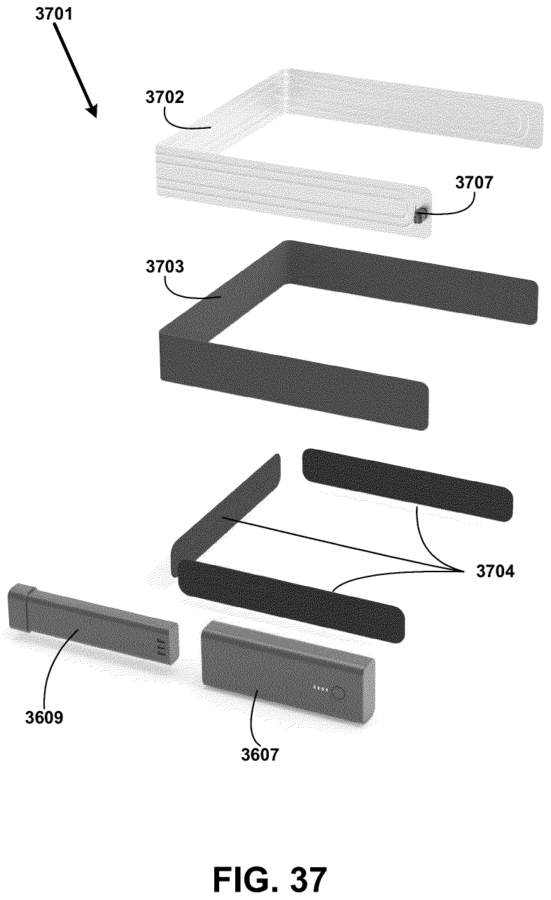

FIG. 37 shows for illustrative purposes only an example only an example of an exploded view of a small pizza delivery bag of one embodiment. FIG. 37 shows the food transport warming system heat plate assembly insert 3701 components. An integrated insulating back layer 3703 is coupled to a heat plate 3702 to provide insulation from a heat plate 3702 protecting a small pizza delivery bag and directing heat inward. A battery box 3607 configured to hold at least one battery 3609. In some embodiments the heat plate 3702 may have a cloth silicone or other material protective covering.

The heat plate assembly insert 3701 is configured to be easily portable so that food can be warmed in multiple diverse and varying small pizza delivery bags 3600 of FIG. 36. The heat plate assembly insert 3701 devices are self-contained and food safe. Power is supplied by a customized rechargeable battery pack 3609. Heating power, charging and battery safety circuits are all contained in the PCBA 3610 of FIG. 36. When the system is activated the PCBA 3610 of FIG. 36 will convert electrical energy to heat energy and disperse it through conductors including for example the heat plate assembly insert 3701 or other conductors of one embodiment.

The battery box 3607 is connected to the heat plate 3702 with a heating plate plug 3707. The heat plate assembly insert 3701 is placed along the sides of the small pizza delivery bag 3600 of FIG. 36 and, in some embodiments; multiple units may be used in one small pizza delivery bag 3600 of FIG. 36. The heat elements transfer heat into the small pizza delivery bag 3600 of FIG. 36 to help keep food warm. The small heat plate assembly insert 3701 systems are attached to the inner surface of the small pizza delivery bag 3600 of FIG. 36 with Velcro 3704 in one embodiment. Other embodiments could include brackets, clips, or other attachment systems.

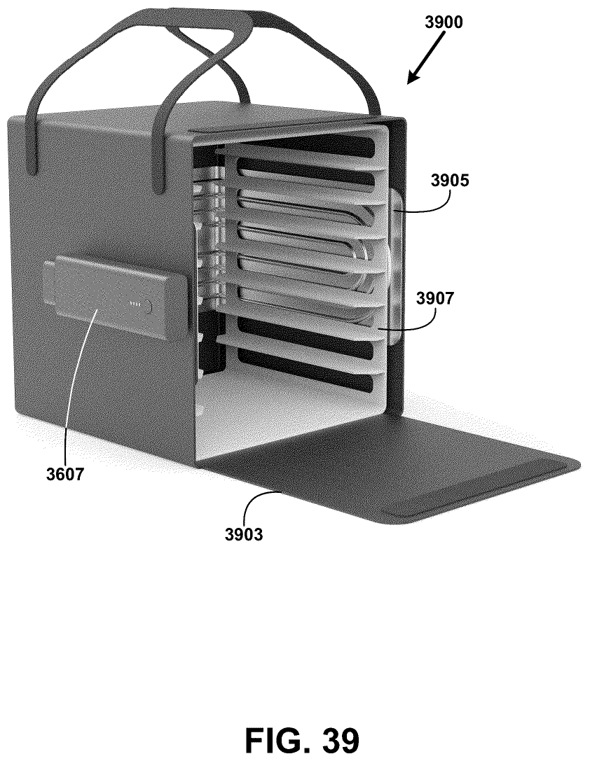

The heat plate assembly insert 3701 may be configured in shapes and sizes for various small pizza delivery bag 3600 of FIG. 36 types and sizes. For example one shape and size for a small pizza delivery bag 3600 of FIG. 36, in another example for a larger pizza delivery bag with an optional shelf system 3907 of FIG. 39. In other embodiments the heat plate assembly insert system devices may be configured for specific food types for example configured in shapes and sizes for various pizza delivery bag types and sizes.

Battery Attachment to Heat Element with Socket:

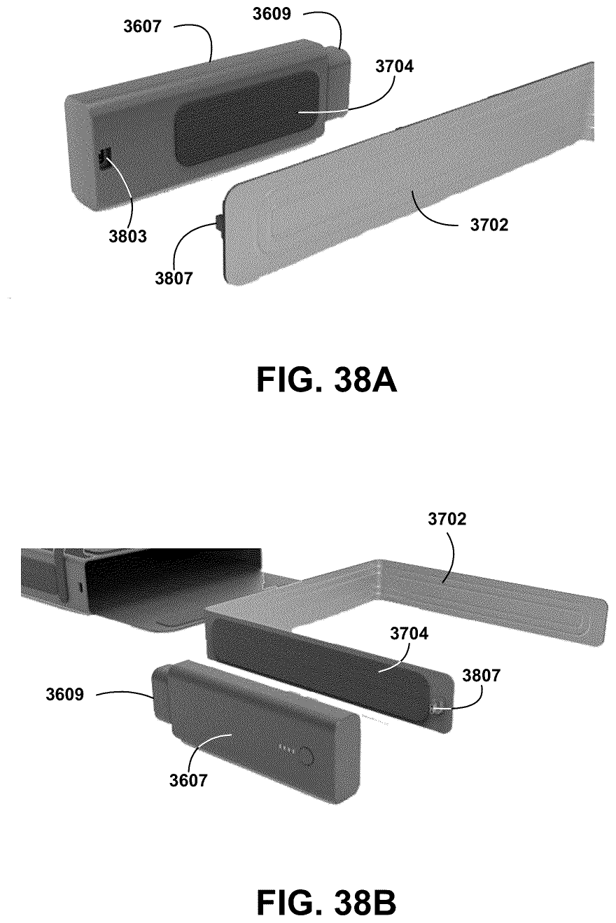

FIG. 38A shows for illustrative purposes only an example of battery attachment to heat element with a socket of one embodiment. FIG. 38A shows the heat plate 3702 connection to battery box 3607 with the battery 3609 of one embodiment. The battery box 3607 contains a heat plate socket 3803. The heat plate 3702 attaches to the battery box 3607 with Velcro 3704 and is electrically connected with a heating plate plug 3807 inserted into a heating plate socket 3803 of one embodiment.

Battery Attachment to Heat Element with Plug:

FIG. 38B shows for illustrative purposes only an example battery attachment to heat element with a plug of one embodiment. The heat plate 3702 contains the heating plate plug 3807. The heating plate plug 3807 inserts directly into the heat plate socket 3803 of FIG. 38A. In other embodiments, a wire or other connection may be utilized.

### Large Pizza Delivery Bag:

FIG. 39 shows for illustrative purposes only an example of an overview of an optional shelf system of one embodiment. FIG. 39 shows a large pizza delivery bag 3900 with a cover 3903 in an opened position, a large heat plate assembly 3905, with an integrated battery box 3607, and an optional shelf system 3907 configured for the capacity to hold multiple pizza boxes or other food products of one embodiment. The large heat assembly 3905 utilizes larger versions of the heat plate assembly insert 3701 of FIG. 36 components. The heat plate assembly insert 3701 of FIG. 36 elements may be produced in different sizes to match various delivery bag options to form the food transport warming system of one embodiment.

### Food Transport Heat System:

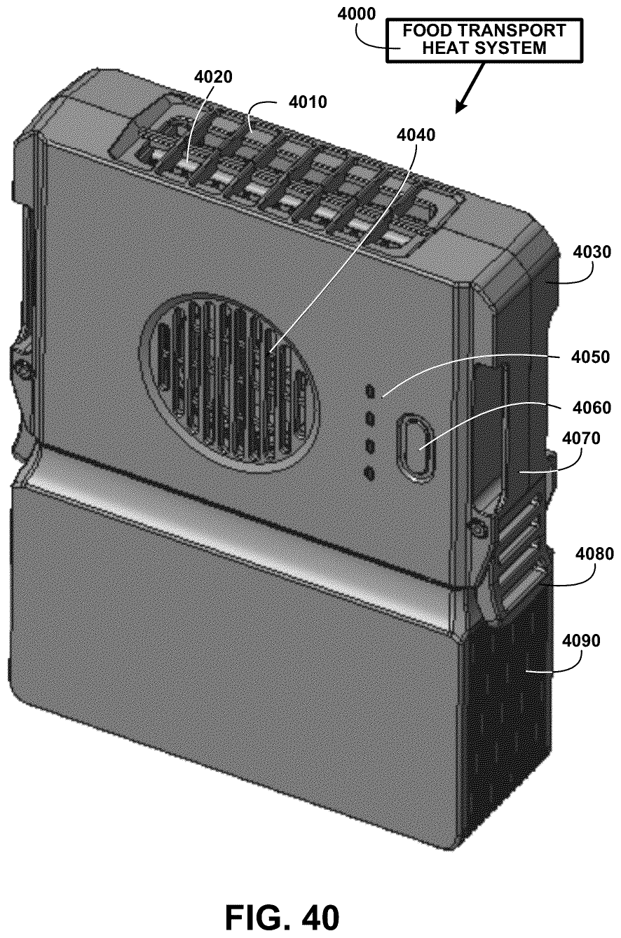

FIG. 40 shows for illustrative purposes only an example of an overview of a food transport heat system of one embodiment. FIG. 40 shows a food transport heat system 4000 including a protective screen 4010 covering the heat element 4020 to prevent accidental burning of fingers or contents. The heater assembly 4030 includes a fan intake 4040 to produce an air flow to disperse the heat generated around the food uniformly. The integral fan is used to circulate heated air through the heating element and inside the container, improving heating effect. LED Power level indicators 4050 allows the user to determine when the batteries may need recharging. The removable high power battery system with LED Power level indicators designed for operation in a high heat environment. A power button 4060 is used to turn the heater assembly 4030 on and off. An alternative attachment options, in one embodiment, a strap attach point 4070 is used to attach a strap for carrying the food transport heat system 4000 and the battery is connected directly to heat assembly 4030 and is secured with latches 4080. The battery assembly 4090 houses the batteries for powering the food transport heat system 4000. The food transport heat system 4000 includes transmitting food status information to a user and receiving user instructions from a user digital device using a food warming system application of one embodiment.

### Heater Assembly:

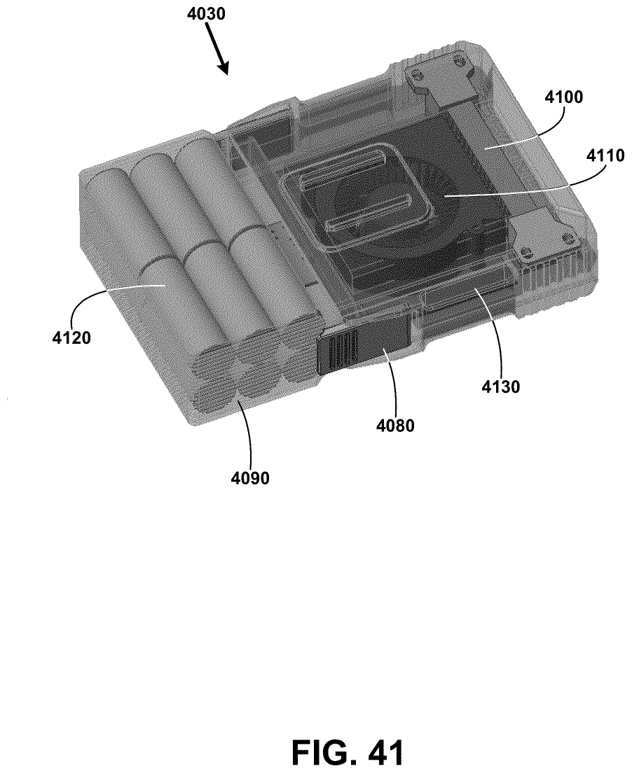

FIG. 41 shows for illustrative purposes only an example of an overview of heater assembly of one embodiment. FIG. 41 shows a heater assembly 4030 that includes at least one heater element 4100, a fan 4110, battery cells 4120, at least one PCBA 4130, a latch 4080 and a battery assembly 4090. The battery cells 4120 are each a rechargeable battery. The battery cells 4120 have high current and heat resistant capability. The battery system is capable of converting electrical energy from high current, heat resistant battery cells 4120 into heater assembly 4030 heat levels capable of providing food safety-in excess of 140°. The control printed circuit board assembly coupled to bluetooth and Wi-Fi connectivity devices is configured for providing communication and control alternatives to the user including voice activated commands. A food warming system application configured for installation into the control printed circuit board assembly; and at least one cellular connectivity device and transceiver coupled to the control printed circuit board assembly configured for transmitting food status information to a user and receiving user instructions from a user digital device using a food warming system application of one embodiment.

### Soft Sided Food Transport Container:

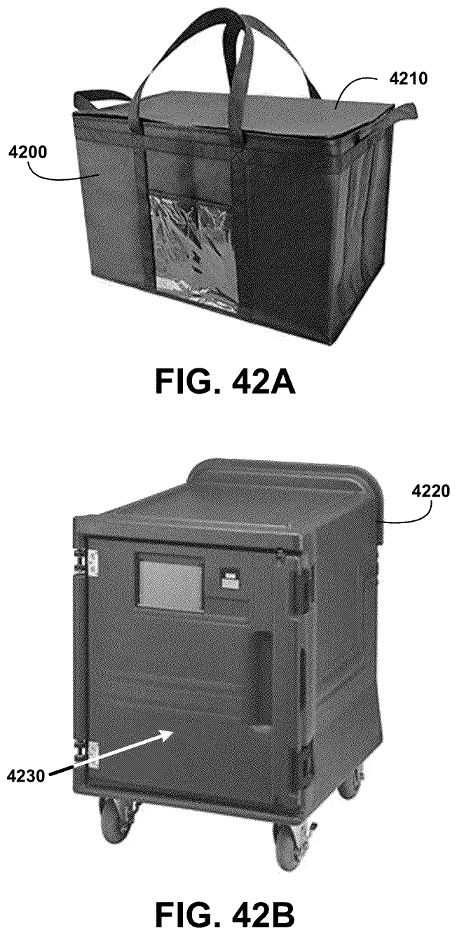

FIG. 42A shows for illustrative purposes only an example of an overview of a soft sided food transport container of one embodiment. FIG. 42A shows a soft sided food transport container 4200 that includes a food container cover 4210 to protect the food from airborne contamination. The soft sided food transport container 4200 allows a person to carry and transport a number of foods comfortable and safely of one embodiment.

### Hard Sided Rolling Food Transport Container:

FIG. 42B shows for illustrative purposes only an example of an overview of a food cart of one embodiment. FIG. 42B shows a hard sided rolling food transport container food cart 4220. The hard sided rolling food transport container food cart 4220 includes a food container door 4230 to prevent any food from sliding out during transport. In one embodiment, the heat system is built directly into the door. The carrying capacity of the hard sided rolling food transport container food cart 4220 allows, for example, multiple meals, and a large assortment of foods for a buffet setting of one embodiment.

### Monitoring Food Temperature in Real Time:

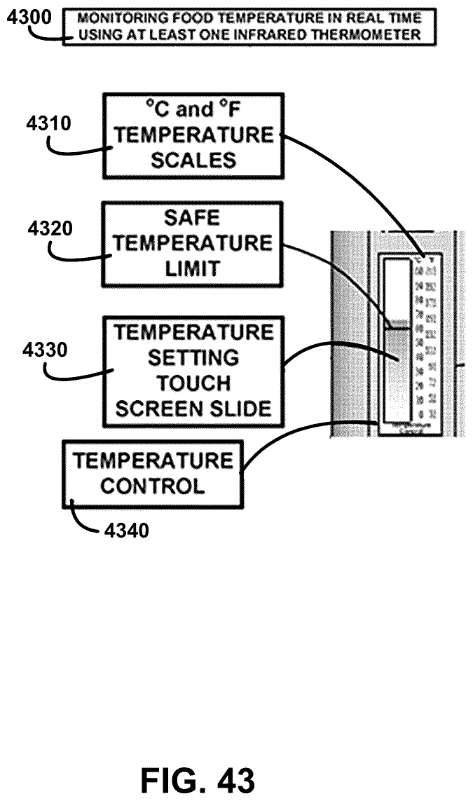

FIG. 43 shows for illustrative purposes only an example of an overview of monitoring food temperature in real time of one embodiment. FIG. 43 shows monitoring food temperature in real time using at least one infrared thermometer 4300. In one embodiment, ultraviolet lights are coupled to the heat module insert and food delivery container cover configured for treating food placed in the food delivery container to kill bacteria, viruses and other food borne pathogens and sterilize the food during the warming and transport processes. At least one infrared thermometer includes ° C. and ° F. temperature scales 4310. Monitoring food temperature in real time maintains the food temperature within a safe temperature limit 4320. Adjustments of the temperature is performed using a temperature setting touch screen slide 4330 as a portion of the temperature control 4340. The temperature control device is also a heat regulator which will turn off the heat element at max temperature and turn the heat element back on at minimum temperature. This cycling effect dramatically increases run time without sacrificing food safety of one embodiment.

### Heater Assembly:

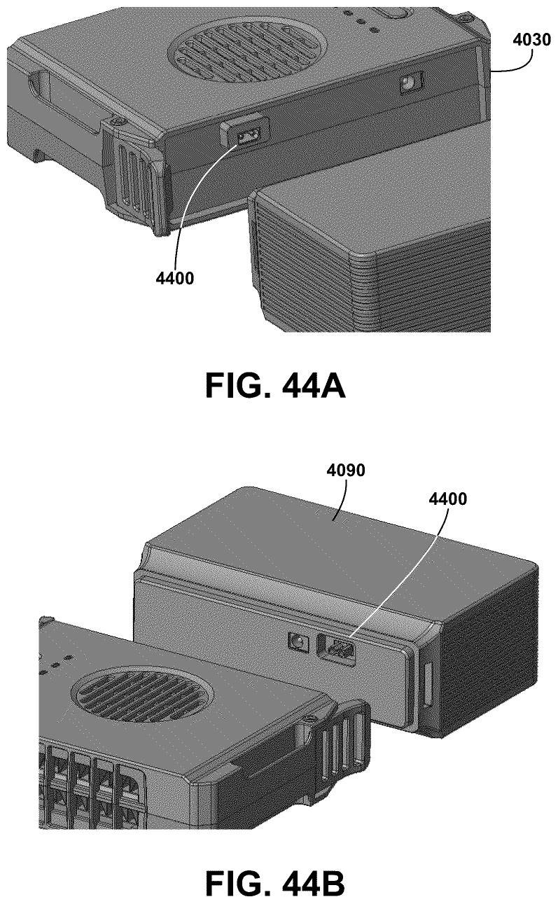

FIG. 44A shows for illustrative purposes only an example of an overview of a heater assembly of one embodiment. FIG. 44A shows a heater assembly 4030 used to heat and maintain a safe temperature of food. The heater assembly 4030 in one embodiment is power using a high current connector 4400 to connect to a high current power source of one embodiment.

### Battery Assembly:

FIG. 44B shows for illustrative purposes only an example of an overview of a battery assembly of one embodiment. FIG. 44B shows a high current connector 4400 to connect a high current source to a battery assembly 4090. The high current connector 4400 is also used to charge batteries of one embodiment.

### Air Flow Director:

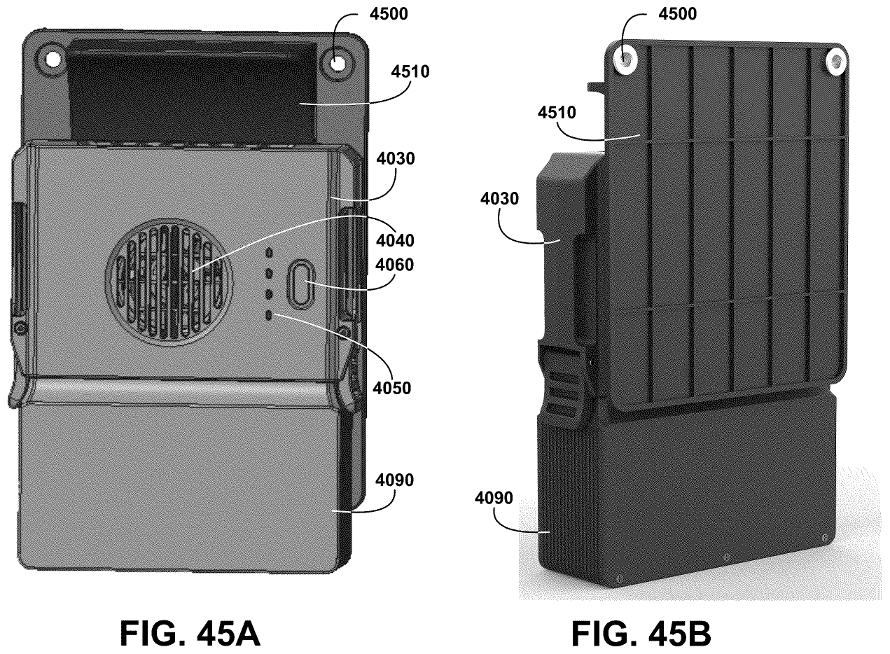

FIG. 45A shows for illustrative purposes only an example of an overview of an air flow director of one embodiment. FIG. 45A shows a mounting plate with snaps 4500 used to connect an air flow director 4510 to a heater assembly 4030. The heater assembly 4030 includes a fan intake 4040 to draw air into the heater assembly 4030 to distribute the heat uniformly around the food in a container. A power button 4060 is used to turn the heater assembly 4030 and its components on and off. An LED power level indicators 4050 displays the remaining charge on a battery assembly 4090 to allow the user an indication of when to recharge the batteries of one embodiment.

Mounting Plate with Snaps:

FIG. 45B shows for illustrative purposes only an example of an overview of a mounting plate with snaps of one embodiment. FIG. 45B shows the mounting plate with snaps 4500 creating a secure connection of a heating container to a food transport bag or box, an air flow director 4510 is connected to the heater assembly 4030 powered by a battery assembly 4090. The mounting plate with snaps 4500 of the integrated heat module with snaps allows for mounting to the heating container. The mounting plate has a curved top to control directional airflow to the sides and center of bag. The secured connection of an air flow director 4510 assures an air flow of the heated air to maintain food safety within a container of one embodiment.

### High Power Multi Battery Charger:

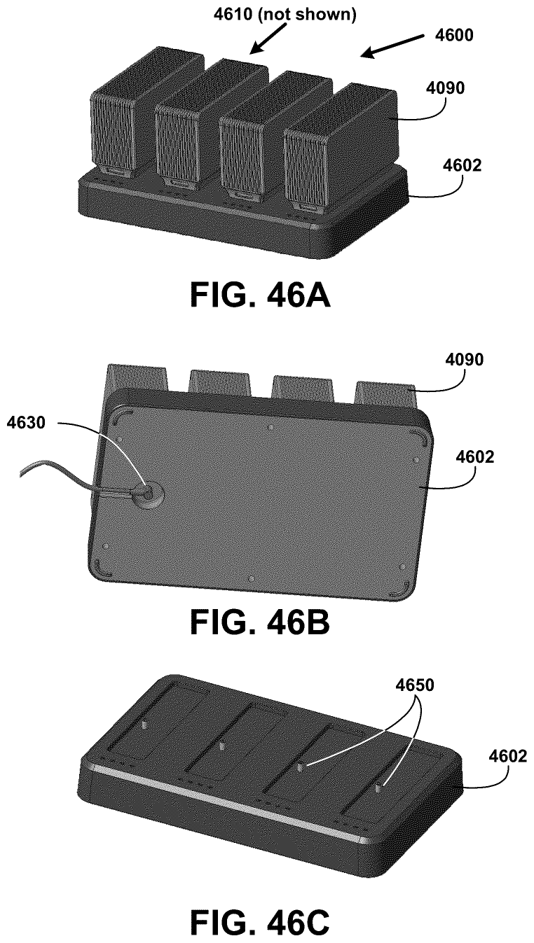

FIG. 46A shows for illustrative purposes only an example of an overview of a high power multi battery charger of one embodiment. FIG. 46A shows a high power multi battery charger 4600 for recharging a battery assembly 4090. The high power multi battery charger 4600 includes a charger base 4602 that displays an LED charge level indicator 4610 (not shown) individually for each of the batteries being charged of one embodiment.

### Charger Base:

FIG. 46B shows for illustrative purposes only an example of an overview of a charger base of one embodiment. FIG. 46B shows the charger base 4620 having a high power charger, high current connection 4630. The high power charger, high current connection 4630 allows additional power and current capacity to effectively charge multiple batteries simultaneously. The charger base 4620 is a multi-unit battery recharging device with integral charge safety circuitry, individual battery control, individual LED charge status indicator 4610, and fast charge capability of the battery assembly 4090 of one embodiment.

### Battery High Current Charge Connectors:

FIG. 46C shows for illustrative purposes only an example of an overview of a battery high current charge connectors of one embodiment. FIG. 46C shows a top view of the charger base 4620. In this view without batteries being in place a series of battery high current charge connectors 4650 are seen. The battery high current charge connectors 4650 insert into the batteries making an electrical connection to conduct the high power high current electricity to be conducted into each battery to recharge to a full power level. The battery pack is specialized for high current output, operation in a high heat environment and rapid recharge of one embodiment.

The foregoing has described the principles, embodiments, and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. A universal heat module insert device for heating food in predetermined transport containers, comprising:
at least one heat module insert device coupled to interior sides of predetermined transport containers configured for heating food at predetermined temperatures while the food is being transported;
at least one removable rechargeable battery coupled to the at least one heat module insert device configured for powering heating plates to heat levels capable of providing food safety-in excess of 140°;
wherein the at least one removable rechargeable battery is configured to have high current and heat resistant capability;
a heating plate coupled to the at least one battery configured to heat food;
an electronic control board coupled to the heating plate to adjustably set heating plate temperatures; and
a heat transfer protective piece coupled to the heating plate configured to shield the heating plate.

2. The universal heat module insert device for heating food in predetermined transport containers of claim 1, further comprising a food temperature monitoring device having at least one infrared thermometer and ultraviolet lights coupled to a heat module insert and food delivery container cover configured to monitor food temperatures in real time.

3. The universal heat module insert device for heating food in predetermined transport containers of claim 1, further comprising a 12V car power adapter device configured to power the heating plate.

4. The universal heat module insert device for heating food in predetermined transport containers of claim 1, further comprising a back support coupled to at least one heat module insert device configured to provide structural support for attachment of the rest of the modules and components.

5. The universal heat module insert device for heating food in predetermined transport containers of claim 1, further comprising a high power charger, high current connection coupled to a transport container battery assembly configured to allow high power and high current capacity to effectively charge a removable battery.

6. The universal heat module insert device for heating food in predetermined transport containers of claim 1, further comprising a charger base having a high power charger, high current connection configured to allow additional power and current capacity to effectively charge multiple removable batteries simultaneously.

7. The universal heat module insert device for heating food in predetermined transport containers of claim 1, further comprising a plurality of ultraviolet lights coupled to a heat module insert and food delivery container cover configured for treating food placed in the food delivery container to kill bacteria, viruses and other food borne pathogens and sterilize the food during a warming and transport processes.

8. An electric chafer transportable food warming module for heating food in a food container, comprising:
an electric chafer transportable food warming module with an electric heat generating plate coupled to a protective heating surface for heating food in a food container to predetermined temperatures;
wherein the protective heating surface is configured to direct the heat to the bottom of the food container adjacent to the protective heating surface for heating the food;
a battery pack comprising at least one removable rechargeable battery configured to have high current and heat resistant capability;
an electric heat generating plate coupled to the battery pack configured for powering the electric heat generating plate to heat levels capable of providing food safety-in excess of 140°;
a frame insulating connective plate coupled to the battery pack configured to insulate the battery pack from the heat generating plate;
a main box bottom with a battery compartment coupled to the frame insulating connective plate configured to contain the battery pack;
an electronic temperature control device coupled to the electric heat generating plate configured to regulate temperatures produced by the electric heat generating plate to maintain predetermined food temperatures while the food is being served;
a temperature setting touch screen slide coupled to the electronic temperature control configured to include digital touch buttons labeled for a plurality of specific food types when pressed will set a preset targeted temperature setting prerecorded in at least one database for the specific food type.

9. The electric chafer transportable food warming module for heating food in a food container of claim 8, further comprising a 12V car power adapter device configured to power the electric heat generating plate.

10. The electric chafer transportable food warming module for heating food in a food container of claim 8, further comprising an optional automatic activation to power the electric heat generating plate when a human consumable container is inserted into an aluminum holder.

11. The electric chafer transportable food warming module for heating food in a food container of claim 8, further comprising a high power charger, high current connection coupled to a transport container battery assembly configured to allow high power and high current capacity to effectively charge a removable battery.

12. The electric chafer transportable food warming module for heating food in a food container of claim 8, further comprising a charger base having a high power charger, high current connection configured to allow additional power and current capacity to effectively charge multiple removable batteries simultaneously.

13. The electric chafer transportable food warming module for heating food in a food container of claim 8, further comprising a food temperature monitoring device having at least one infrared thermometer and ultraviolet lights coupled to a heat module insert and food delivery container cover configured to monitor food temperatures in real time.

14. The electric chafer transportable food warming module for heating food in a food container of claim 8, further comprising a plurality of ultraviolet lights coupled to a heat module insert and food delivery container cover configured for treating food placed in the food delivery container to kill bacteria, viruses and other food borne pathogens and sterilize the food during a warming and transport processes.

15. A transport container for maintaining predetermined temperatures of human consumables during transport, comprising:
a transport container configured for maintaining predetermined temperatures of human consumables for transport to a consumer;
a plurality of aluminum holders coupled to the transport container configured to hold related human consumable containers;
a continuous heat plate coupled to each aluminum holder configured to transfer heat at predetermined temperatures to the related human consumable containers;
wherein the continuous heat plate is configured to be activated automatically when a human consumable container is inserted into an aluminum holder;
an electronic control board coupled to the continuous heat plate configured for controlling power flow, temperature, charging and all battery safety protocols;
an aluminum protect plate coupled to the continuous heat plate configured for transferring heat directly into the plurality of aluminum holders;
a waterproof seal coupled to the aluminum protect plate configured to prevent spillage into an electronic compartment below and aid in cleaning;
wherein the plurality of aluminum holders are adjacent to the top surface of the aluminum protect plate configured for transferring heat into human consumable container liquids;
wherein the plurality of aluminum holders are configured to maintain cooled human consumables temperatures with ice deposited into the transport container;
a rechargeable battery pack comprising at least one removable battery configured to have high current and heat resistant capability; and
wherein the rechargeable battery pack is coupled to the continuous heat plate and coupled to the electronic control board configured to power the continuous heat plate to maintain predetermined temperatures to heat levels capable of providing food safety-in excess of 140° of the plurality of aluminum holders human consumable container foods and liquids.

16. The transport container for maintaining predetermined temperatures of human consumables during transport of claim 15, further comprising a 12V car power adapter device configured to power the continuous heat plate.

17. The transport container for maintaining predetermined temperatures of human consumables during transport of claim 15, further comprising an optional automatic activation to power the continuous heat plate when a human consumable container is inserted into an aluminum holder.

18. The transport container for maintaining predetermined temperatures of human consumables during transport of claim 15, further comprising a high power charger, high current connection coupled to the transport container battery assembly configured to allow high power and high current capacity to effectively charge a removable battery.

19. The transport container for maintaining predetermined temperatures of human consumables during transport of claim 15, further comprising a charger base having a high power charger, high current connection configured to allow additional power and current capacity to effectively charge multiple batteries simultaneously.

20. The transport container for maintaining predetermined temperatures of human consumables during transport of claim 15, further comprising a food temperature monitoring device having at least one infrared thermometer and ultraviolet lights coupled to a heat module insert and food delivery container cover configured to monitor food temperatures in real time.
